(19) United States
(12) Patent Application Publication
(10) Pub. No.: US 2023/0396959 A1
(43) Pub. Date: Dec. 7, 2023

(54) METHODS AND SYSTEMS FOR DETERMINING DEVICE LOCATION

(71) Applicant: COMCAST CABLE COMMUNICATIONS, LLC, Philadelphia, PA (US)

(72) Inventors: Gaurav Naik, Philadelphia, PA (US); David Luksenberg, Philadelphia, PA (US)

(21) Appl. No.: 17/829,997

(22) Filed: Jun. 1, 2022

(51) Int. Cl. H04W 4/029; H04W 4/02; H04W 4/80

(52) U.S. Cl. CPC H04W 4/029; H04W 4/027; H04W 4/80

(57) ABSTRACT

A computing device may receive a signal from a first device and, based on the signal, determine a location of the first device. The computing device may determine that the first device is in motion, and may stop, while the first device is in motion, determining a location of the first device. The computing device may determine that the first device is no longer in motion, and resume determining the location of the first device.

### BACKGROUND

For certain wireless protocols, the number of channels available for initiating a communication session may be limited. Furthermore, most receiving devices only monitor a single channel at a time for initiating the communication session. As the number of devices in an area attempting to initiate a session increases, the lack of an available channels to initiate the communication may extend the time before each device is able to initiate its own communication session. Further, when multiple channels for initiating the communication session are available, the chance the sending device and receiving device will be attempting to initiate the communication session on the same channel may further extend the time before each device is able to initiate its own communication session.

### SUMMARY

It is to be understood that both the following general description and the following detailed description are exemplary and explanatory only and are not restrictive. Methods and systems for determining device location are described.

One or more computing devices may be tasked with monitoring the location of devices, such as equipment and other assets, within an area. The computing devices may determine the location of the devices based on signals received from the devices over time. When one or more of these devices are in motion it may be desirable to not determine the location of the moving devices. The computing device may determine that one or more of the devices are in motion and may stop determining the location of those one or devices during the time of movement. Once the computing device determines that these one or more devices are no longer moving, the computing device may begin determining the location of those devices once again.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for determining a location of one or more devices;

FIG. 2 shows another example system for determining a location of one or more devices;

FIG. 3 shows a flowchart of an example method for managing device location determination for one or more devices;

FIG. 4 shows a flowchart of an example method for managing device location determination for one or more devices;

FIG. 5 shows a flowchart of an example method for managing device location determination for one or more devices;

FIG. 6 shows a flowchart of an example method for managing device location determination for one or more devices;

FIG. 7 shows a flowchart of an example method for managing device location determination for one or more devices;

FIG. 8 shows a flowchart of an example method for managing device location determination for one or more devices;

FIG. 9 shows a flowchart of an example method for sending signals for device location determination for a device;

FIG. 10 shows a flowchart of an example method for monitoring for communication signals associated with one or more devices;

FIG. 11 shows a flowchart of an example method for monitoring for communication signals associated with one or more devices

FIG. 12 shows a flowchart of a method for determining a coordinator scanner of a plurality of wireless scanners in an area; and

FIG. 13 shows a block diagram of an example computing device for determining the locations of a plurality of devices.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

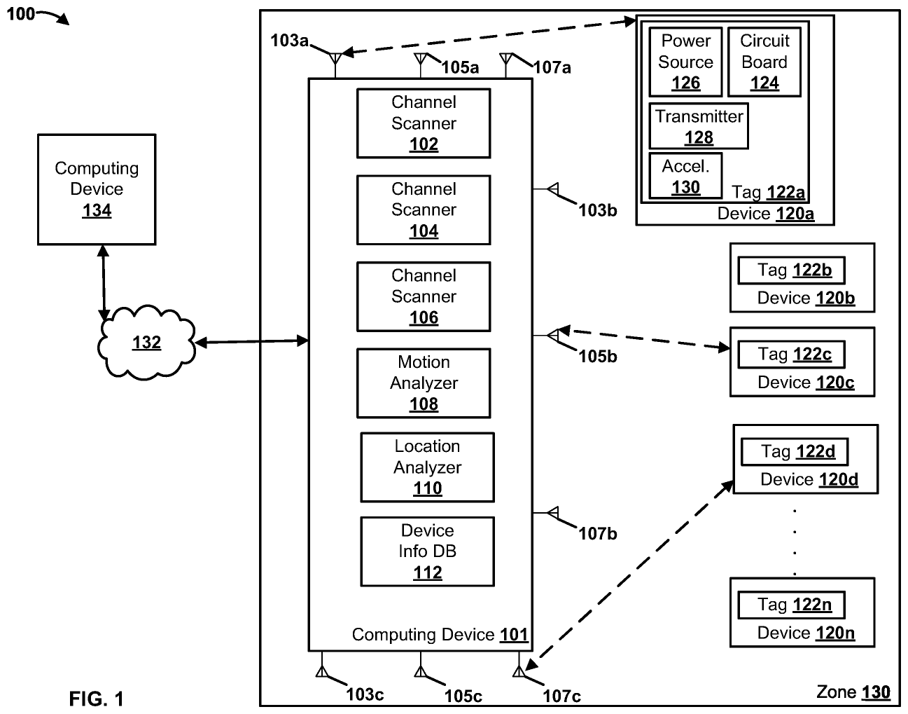

FIG. 1 shows an example system 100. The example system 100 may be configured for determining the locations of a plurality of devices. Although only certain devices and/or components are shown, the system 100 may comprise a variety of other devices and/or components that support a wide variety of network and/or communication functions, operations, protocols, and/or the like. The system 100 may comprise a plurality of computing devices/devices/wireless tags in communication via a network 132. The network 132 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 132 via a variety of transmission paths, including wireless paths (e.g., satellite paths, Wi-Fi paths, cellular paths, etc.) and terrestrial paths (e.g., wired paths, a direct feed source via a direct line, etc.). The network 132 may comprise public networks, private networks, wide area networks (e.g., Internet), local area networks, and/or the like. The network 132 may be configured to provide motion data, signaling data, and/or location data for a plurality of devices using a variety of network paths, protocols, devices, and/or the like. The network 132 may deliver motion data, signaling data, and/or location data for a plurality of devices 120a-n from a computing device 101 (e.g., a wireless scanning device) to one or more other computing devices (e.g., the remote computing device 134).

The system 100 may comprise the one or more computing devices 101, each of which may be or include a wireless scanning device or other computing device. Each computing device 101 may receive a plurality of signals providing information related to one or more devices 120a-n. The signals may be wireless signals. For example, the signals may be any one of a Bluetooth signal, a Bluetooth low energy (BLE) signal, a Wi-Fi signal, a ZigBee signal, an ultra-wide band (UWB) signal, a controller area network (CAN) bus signal, an RS485 signal, a near-field communication (NFC) signal, or a long range, low power (LoRa) signal. For example, the signals may be advertising signals transmitted on an advertising channel of the particular wireless transmission protocol. For example, the signals may be a Bluetooth or BLE advertising signals transmitted on one of Bluetooth or BLE channels 37-39.

For example, each signal may comprise one or more data packets. The data packets may comprise an advertising packet header and a packet body. The signals (e.g., the data packet) may include a device identifier (ID) for the wireless tag 122a-n and/or associated device 120a-n, the capabilities of the wireless tag sending the signal, the functionality of the wireless tag sending the signal, and/or the intention of the wireless tag sending the signal. The device ID may identify the wireless tag 122a-n, sending the signal and/or the associated device 120a-n to which the particular wireless tag is connected.

The capabilities data of the wireless tag 122a-n sending the signal may include whether the wireless tag 122a-n is a connectible or non-connectible device and/or the low energy features supported by the wireless tag 122a-n. The functionality data of the wireless tag 122a-n sending the signal may include transmit power level, service data, the type of advertising device, an advertising interval, and/or a uniform resource identifier. The intention data of the wireless tag 122a-n sending the signal may include whether the wireless tag intends to communicatively connect to the computing device 101 or if the wireless tag 122a-n intends to not connect but instead transmit information (e.g., broadcast) to the computing device 101.

The data packet of the signal, or another portion of the signal, may also include motion data. The motion data may be any form of data that indicates whether the wireless tag 122a-n sending the signal and the associated device 120a-n are in motion or are immobile (e.g., not in motion). The motion data may be data received from an accelerometer (e.g., accelerometer 130), velocity meter, or other motion-sensing device associated with the wireless tag 122a-n sending the signal.

Each of the plurality of signals may be received by the computing device 101 via one of a plurality of wireless channel scanners 102, 104, 106 (hereinafter referred to as “scanners”). While the example of FIG. 1 shows three scanners 102, 104, 106, this is for example purposes only, as the computing device 101 may include a fewer or greater quantity of scanners 102, 104, 106. For example, the number of scanners 102, 104, 106 included with the computing device 101 may be greater than or equal to the number of advertising channels available on the wireless protocol being monitored by the scanners 102, 104, 106. For example, as the Bluetooth or BLE communications protocol includes three advertising channels, the computing device 101 may include three or more scanners 102, 104, 106 in order to be able to monitor each advertising channel for signals during the same time period (e.g., a scan window). For example, each of the scanners 102, 104, 106 may be Bluetooth or BLE scanners. For example, each of the Bluetooth or BLE scanners 102, 104, 106 may be configured as a Bluetooth or BLE system on a chip (SOC). Each scanner 102, 104, 106 may include a receiver or transceiver for receiving or receiving and transmitting data, such as the signals and the data associated with the signals. Each scanner 102, 104, 106 may be configured to monitor (e.g., listen or scan) a plurality of channels of a particular wireless protocol (e.g., Bluetooth, BLE, Wi-Fi, ZigBee, UWB, a CAN bus, RS485, NFC, or LoRa). Each scanner 102, 104, 106 may be configured to monitor the same or different channels as each other scanner 102, 104, 106. For example, each scanner 102, 104, 106 may be configured to receive signals from a different wireless tag 122a-n simultaneously or at substantially the same time (e.g., during the same scan window).

The computing device 101, may also include one or more antennas. Each antenna may be associated with one or more scanners and may be configured to receive wireless signals from one or more of the wireless tags 122a-n. For example, the first scanner 102 may be associated with and/or communicatively coupled to one or more antennas 103a-c. While the example of FIG. 1 shows three antennas 103a-c associated with the first scanner 102, this is for example purposes only, as fewer or greater numbers of antenna may be communicatively coupled to the first scanner 102. Each of the antennas 103a-c may be positioned along a different portion of the computing device 101 or first scanner 102 or aimed in a different direction from the computing device 101 or first scanner 102. In certain examples, the antennas 103a-c may only be used by the first scanner 102, while in other examples, the antennas 103a-c may be shared and used simultaneously or at different times by each of the scanners 102, 104, 106 of the computing device 101. In certain examples, the computing device 101 may include only a single antenna that is used by each of the scanners 102, 104, 106 simultaneously. The computing device 101 may determine which antenna 103a-c will be used by the first scanner 102 to monitor a channel of the wireless protocol.

For example, the second scanner 104 may be associated with and/or communicatively coupled to one or more antennas 105a-c. While the example of FIG. 1 shows three antennas 105a-c associated with the second scanner 104, this is for example purposes only, as fewer or greater numbers of antenna may be communicatively coupled to the second scanner 104. Each of the antennas 105a-c may be positioned along a different portion of the computing device 101 or second scanner 104 or aimed in a different direction from the computing device 101 or second scanner 104. The computing device 101 may determine which antenna 105a-c will be used by the second scanner 104 to monitor a channel of the wireless protocol. For example, the third scanner 106 may be associated with and/or communicatively coupled to one or more antennas 107a-c. While the example of FIG. 1 shows three antennas 107a-c associated with the third scanner 106, this is for example purposes only, as fewer or greater numbers of antenna may be communicatively coupled to the third scanner 106. Each of the antennas 107a-c may be positioned along a different portion of the computing device 101 or third scanner 106 or aimed in a different direction from the computing device 101 or third scanner 106. The computing device 101 may determine which antenna 107a-c will be used by the third scanner 106 to monitor a channel of the wireless protocol.

The computing device 101 may comprise a motion analyzer module 108. The motion analyzer module 108 may be configured to determine if a device 120a-n, associated with a wireless tag 122a-n from which a signal is received, is in motion. For example, the motion analyzer module 108 may determine if the device 120a-n is in motion based on motion data included in the received signal from one of the wireless tags 122a-n. The motion data may be any form of data that indicates whether the wireless tag 122a-n and the associated device 120a-n are in motion or are not in motion (e.g., immobile). The motion data may comprise data received from an accelerometer, velocity meter, or other motion-sensing device associated with a particular wireless tag 122a-n. The motion data may comprise a quantity of acceleration, a quantity of velocity, or an indication of motion (e.g., in motion, not in motion) for the particular wireless tag 122a-n and the associated device 120a-n to which the tag is coupled.

For example, the motion analyzer module 108 may determine if the device 120a-n is in motion based on motion data derived from the received signal received by one of the scanners 102, 104, 106 from one of the wireless tags 122a-n. For example, the computing device 101 (or the associated scanner 102, 104, 106 that received the signal) may determine the received signal strength indicator (RSSI) quantity or value for the received signal. The motion analyzer module 108, may compare the RSSI quantity for the received signal to a second RSSI quantity of another signal from the same wireless tag 122a-n associated with the same device 120a-n that sent the received signal. For example, the another signal may be the most recent prior signal received from the particular wireless tag 122a-n as the received signal. The motion analyzer module 108 may retrieve the second RSSI quantity from the device information database 112 or another storage medium based on the device ID associated with the received signal. The motion analyzer module 108 may determine, based on the comparison, that the particular wireless tag 122a-n and associated device 120a-n is in motion based on a difference between the first RSSI quantity and the second RSSI quantity. For example, the computing device 101 may determine that the device 120a-n is in motion based on a difference between the first RSSI quantity and the second RSSI quantity satisfying a RSSI threshold.

The computing device 101 may comprise a location analyzer module 110. The location analyzer module 110 may be configured to determine the location of one or more of the devices 120a-n. The location analyzer module 110 may be configured to determine the location of each device within the zone 130 of an area. Each zone 130 may be a room, a portion of the room, a plurality of rooms, a portion of a floor, or the floor of a building, or a portion of an outdoor area. For example, the location analyzer module 110 may determine the location of a device 120a-n based on the received signal from the wireless tag 122a-n associated with the particular device 120a-n. For example, the location analyzer module 110, may determine the scanner 102, 104, 106 that received the signal. The location analyzer module 110 may determine the location of the scanner 102, 104, 106 receiving the signal. For example, the scanner location may be stored in the device information database 112 or another storage medium and may be accessed based on the scanner identifier for the particular scanner 102, 104, 106. The location analyzer module 110 may determine the location of the device 120a-n based on the location of the scanner and the RSSI for the received signal at the particular scanner 102, 104, 106 or time difference of arrival (TDoA) for the signal.

For example, the computing device 101 may determine the location of the device 120a-n based on multiple signals received from the wireless tag 122a-n associated with the device 120a-n and the RSSI or TDoA for each of those signals. For example, the computing device 101 may determine the location based on triangulation of at least a portion of multiple signals (e.g., including the signal) from the wireless tag 122a-n using the RSSI or TDoA for each of those signals or other known techniques. For example, the signal may be received by the first scanner 102, a second signal, from the same wireless tag 122a-n associated with the same first device 120a-n as the signal, may be received at the second scanner 104, and a third signal, from the same wireless tag 122a-n associated with the same first device 120a-n as the signal and the second signal, may be received by the third scanner 106. The location analyzer module 110 may determine the location of the device 120a-n based on the received signal, second signal, and third signal and the RSSI or TDoA of each of the signal, second signal, and third signal. For example, the location analyzer module 110 may determine the location of the device 120a-n based on the known location of the computing device 101 (e.g., stored in the device information database 112 or another storage medium and triangulation of the signal, second signal, and third signal, and the RSSI or TDoA of each signal.

The computing device 101 may comprise a device information database 112. The device information database 112 may be any form of database or memory storage and may be within or communicatively coupled to the computing device 101. The device information database 112 may comprise data record entries or tables of data associated with determining the location of the plurality of devices 120a-n. For example, the device information database 112 may include the signal or signal data (e.g., the device ID, the capabilities of the wireless tag 122a-n sending the signal, the functionality of the wireless tag 122a-n sending the signal, and/or the intention of the wireless tag sending the signal), motion data for the wireless tag 122a-n and associated device 120a-n, the RSSI for each signal, the scanner identifier identifying the scanner 102, 104, 106 that received each signal from the particular wireless tag 122a-n, the location of each computing device 101 and/or each scanner 102, 104, 106 within each zone (e.g., zone 130) and/or the determined location of each device 120a-n and/or wireless scanner 122a-n within each zone.

The system 100 may comprise a remote computing device 134. The remote computing device 134 may be positioned at a location away from the area (e.g. one or more zones, such as zone 130) being monitored. The remote computing device 134 may be a personal computer, computing station, workstation, portable computer, laptop computer, a network computer, a server or cloud computing device, and so on.

The computing device 101 may be configured to provide data associated with the received plurality of signals via a wired or a wireless network connection, such as the network 132, to a remote computing device 134. For example, the computing device 101 may send data associated with the plurality of signals to the remote computing device 134 via long-term evolution (LTE), long range wide area network (LoRaWAN), narrowband internet of things (NB-IoT), Wi-Fi, ZigBee Bluetooth, BLE, SigFox, Ethernet, or via any other wired or wireless network.

In examples where the computing device 101 determines the location of the plurality of devices 120a-n based on the received signal(s), the data may comprise location data for one or more devices 120a-n, and a device ID identifying the particular device 120a-n in that location. The data may also include an identifier of the computing device 101 and/or the scanner 102, 104, 106 that received the signal for the particular device 120a-n. The data may also include an indication whether each particular device 120a-n is determined to be mobile or at rest.

In examples where the remote computing device 134 is configured to determine the location of the plurality of devices 120a-n based on received signals at the computing device 101, the data may comprise, the signal or signal data (e.g., the device ID, the capabilities of the wireless tag 122a-n sending the signal, the functionality of the wireless tag 122a-n sending the signal, and/or the intention of the wireless tag sending the signal), motion data for the wireless tag 122a-n and associated device 120a-n, the RSSI for the signal, the scanner identifier identifying the scanner 102, 104, 106 that received the signal from the particular wireless tag 122a-n.

The remote computing device 134 may include a motion analyzer module and location analyzer module that operate in substantially the same manner as that described of the motion analyzer module 108 and the location analyzer module 110 of the computing device 101. The remote computing device 134 may also include a device information database for storing all or a portion of one or more of the signal data, the RSSI for each signal, the motion data, the zone identifier, the scanner identifier, the area identifier, the determined motion status for a device 120a-n, or the determined location for each device of the plurality of devices 120a-n, the location of each computing device 101 and/or each scanner 102, 104, 106 within each zone (e.g., zone 130) and/or the determined location of each device 120a-n and/or wireless scanner 122a-n within each zone.

The system 100 may comprise the plurality of devices 120a-n. A portion of the plurality of devices 120a-n may be located within a first zone 130 of an area being monitored. Other portions of the plurality of devices 120a-n may be located within another zone of a plurality of zones within the area being monitored. Each device of the plurality of devices 120a-n may not be in motion (e.g., immobile or stationary) at certain times and moving at other times. Any device of the plurality of devices 120a-n may be moved from one part of a zone to another part of the zone, from one zone to another zone, or from a zone to another area that may or may not be monitored. The device 120a-n may be one or more of a device, a part, a piece of equipment, a computing device, machinery, a tool, a provision, material, an asset or the like. While the example of FIG. 1 shows five devices 120a-n, this is for example purposes only as the quantity of devices 120a-n in the area being monitored and/or within a particular zone (e.g., zone 130) can be in the tens, hundreds, or even thousands of devices 120a-n.

The system 100 may comprise a plurality of wireless tags 122a-n. Each wireless tag 122a-n may be associated with a corresponding one of the devices 120a-n, such that each device 120a-n may have an individual wireless tag 122a-n associated with the device 120a-n. Each wireless tag 122a-n may be configured to send a wireless signal according to a wireless protocol. For example, the wireless protocol may be any one of Bluetooth, BLE, Wi-Fi, ZigBee, UWB, CAN bus, RS485, NFC, or LoRa. For example, the signal may be an advertising signal transmitted on an advertising channel of the particular wireless protocol. For example, the signal may be a Bluetooth or BLE advertising signal transmitted on one of Bluetooth or BLE channels 37-39. For example, the signal may comprise a data packet. The data packet may comprise an advertising packet header and a packet body. The signal (e.g., the data packet) may include a device identifier (ID), the capabilities of the wireless tag, the functionality of the wireless tag, the intention of the wireless tag, and/or motion data.

Each wireless tag 122a-n may comprise one or more of a circuit board 124, a power source 126, or a transmitter 128. For example, the circuit board 124 may be a printed circuit board or any other type of circuit board. For example, the power source 126 may be a battery. For example, the transmitter 128 may be a transmitter or a transceiver.

Each wireless tag 122a-n may comprise an accelerometer 130, velocity meter, or other motion-sensing device for indicating motion. For example, the accelerometer 130, velocity meter, or other motion sensing device may be coupled to or incorporated into and communicatively coupled with the wireless tag 122a-n. The accelerometer 130, velocity meter, or other motion-sensing device may be configured to generate motion data. The motion data may comprise a quantity of acceleration, a quantity of velocity, or an indication of motion (e.g., in motion, not in motion) for the particular wireless tag 122a-n and the associated device 120a-n to which the tag is coupled. The motion data may be provided by the accelerometer 130, velocity meter, or other motion-sensing device to the wireless tag 122a-n that the accelerometer 130, velocity meter, or other motion-sensing device is coupled or communicatively coupled to. For example, the wireless tag 122a-n may include the motion data in or append the motion data to the advertising packet of the signal. For example, the wireless tag 122a-n may evaluate the motion data and determine whether to send (e.g., broadcast) the advertising signal based on the motion data. For example, the wireless tag 122a-n may send the signal if motion data indicates that the wireless tag 122a-n (and thus the corresponding device 120a-n) is not in motion (e.g., at rest or immobile), and may not send the signal if the motion data indicates that the wireless tag 122a-n (and thus the corresponding device 120a-n) is in motion. While the example of FIG. 1 shows five wireless tags 122a-n, this is for example purposes only, as the quantity of wireless tags 122a-n in the area being monitored and/or within a particular zone (e.g., zone 130) can be in the tens, hundreds, or even thousands to correspond with the quantity of devices 120a-n for which the location is being monitored.

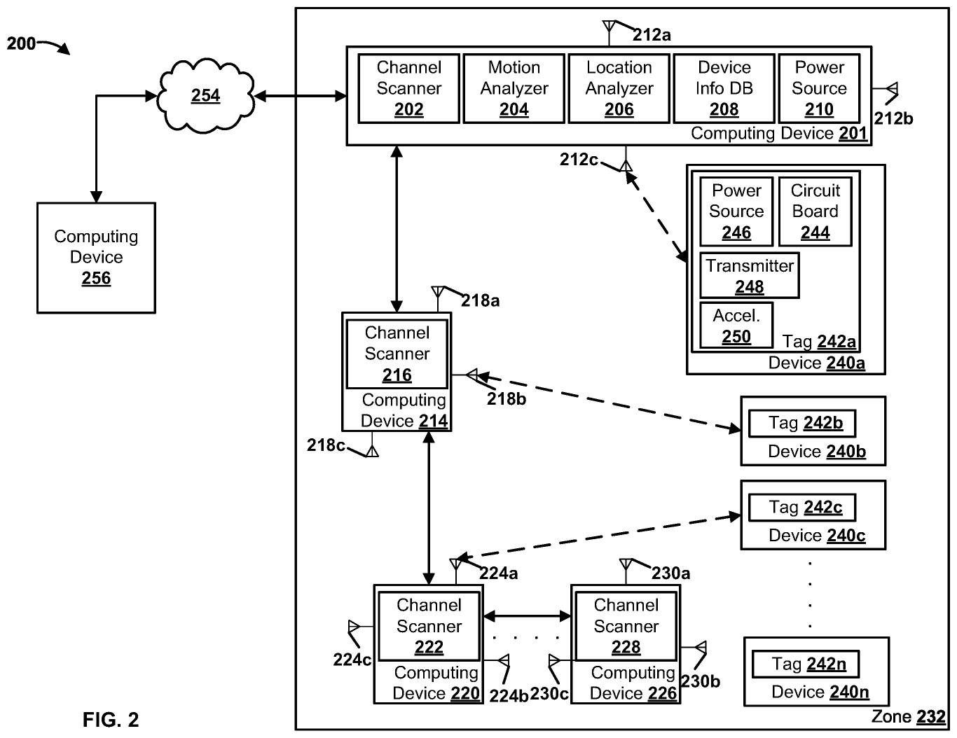

FIG. 2 shows an example system 200. The example system 200 may be configured for determining the locations of a plurality of devices. Although only certain devices and/or components are shown, the system 200 may comprise a variety of other devices and/or components that support a wide variety of network and/or communication functions, operations, protocols, and/or the like. The system 200 may comprise a plurality of computing devices/devices/wireless tags in communication via a network 254. The network 254 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 254 via a variety of transmission paths, including wireless paths (e.g., satellite paths, Wi-Fi paths, cellular paths, etc.) and terrestrial paths (e.g., wired paths, a direct feed source via a direct line, etc.). The network 254 may comprise public networks, private networks, wide area networks (e.g., Internet), local area networks, and/or the like. The network 254 may be configured to provide motion data, signaling data, and/or location data for a plurality of devices using a variety of network paths, protocols, devices, and/or the like. The network 254 may deliver motion data, signaling data, and/or location data for a plurality of devices 240a-n from one or more of the computing devices 201, 214, 220, 226 (e.g., each a wireless scanning device) to one or more other computing devices (e.g., the remote computing device 256).

The system 200 may comprise the one or more computing devices 201, 214, 220, 226, each of which may be or include a wireless scanning device or other computing device. Each computing device 201, 214, 220, 226 may receive a plurality of signals providing information related to one or more devices 240a-n. The signals may be wireless signals. For example, the signals may be any one of a Bluetooth signal, a BLE signal, a Wi-Fi signal, a ZigBee signal, a UWB signal, a CAN bus signal, a RS485 signal, a NFC signal, or a LoRa signal. For example, the signals may be advertising signals transmitted on an advertising channel of the particular wireless transmission protocol. For example, the signals may be a Bluetooth or BLE advertising signals transmitted on one of Bluetooth or BLE channels 37-39.

For example, each signal may comprise one or more data packets. The data packets may comprise an advertising packet header and a packet body. The signals (e.g., the data packet) may include a device identifier (ID) for the wireless tag 242a-n and/or associated device 240a-n, the capabilities of the wireless tag sending the signal, the functionality of the wireless tag sending the signal, and/or the intention of the wireless tag sending the signal. The device ID may identify the wireless tag 242a-n, sending the signal and/or the associated device 240a-n to which the particular wireless tag is connected.

The data packet of the signal, or another portion of the signal, may also include motion data. The motion data may be any form of data that indicates whether the wireless tag 242a-n sending the signal and the associated device 240a-n are in motion or are not in motion (e.g., immobile). The motion data may be data received from an accelerometer (e.g., accelerometer 250), velocity meter, or other motion-sensing device associated with the wireless tag 242a-n sending the signal.

The computing devices 201, 214, 220, 226 may be a portion of a plurality of computing devices in the area being monitored. Each of the plurality of computing devices may include a scanner (e.g., scanner 202, 216, 222, 228) for receiving signals from one or more wireless tags (e.g., wireless tags 242a-n) within a zone. Each computing device 201, 214, 220, 226 may include one or more antennas (e.g., antennas 212a-c, 218a-c, 224a-c, 230a-c) that are coupled to or communicatively coupled with the respective scanner 202, 216, 222, 228 of the corresponding computing device 201, 214, 220, 226. For computing devices having more than one antenna, each antenna associated with the computing device 201, 214, 220, 226 may be positioned along a different portion of the computing device 201, 214, 220, 226 or associated scanner 202, 216, 222, 228 or aimed in a different direction from the computing device 201, 214, 220, 226 or scanner 202, 216, 222, 228.

Each computing device 201, 214, 220, 226, and thus each respective scanner 202, 216, 222, 228, within the zone 232 may be communicatively connected to one another to coordinate scanning activities between the computing devices 201, 214, 220, 226. For example, the computing devices 201, 214, 220, 226 may be communicatively connected via a data bus (not shown). For example, the computing devices 201, 214, 220, 226, may be communicatively coupled to one-another via wireless or wired (e.g., Ethernet cable) communications. The computing devices 201, 214, 220, 226 may be configured to communicate with one-another via Bluetooth, BLE, LoRa, UWB, Wi-Fi, CAN Bus, RS485 or any other wired or wireless protocol. The computing devices 201, 214, 220, 226 may be separately powered (e.g., with individual power sources) or the computing devices 201, 214, 220, 226 may be configured to share one or more power sources. For example, one computing device (e.g., computing device 201 may include a power source (e.g., power source 210) and the computing devices 201, 214, 220, 226 may share the power source 210 to power all of the computing devices 201, 214, 220, 226. While the example of FIG. 2 shows each of the computing devices 201, 214, 220, 226 positioned within the zone 232, in other examples, at least a portion of the computing devices communicatively coupled together may be in one or more other zones.

Each scanner 202, 216, 222, 228 of each computing device 201, 214, 220, 226 may be configured to scan one or more channels of a wireless communication protocol. For example, the wireless communication protocol may be at least one of Bluetooth, BLE, Wi-Fi, ZigBee, UWB, CAN bus, RS485, NFC, or LoRa. For example, each scanner 202, 216, 222, 228 may be configured to scan an advertising channel of the particular wireless transmission protocol. For example, each scanner 202, 216, 222, 228 may be configured to scan the Bluetooth or BLE advertising channels (e.g., Bluetooth or BLE channels 37-39).

Each of the plurality of signals may be received by one of the computing devices 201, 214, 220, 226 via one of a plurality of scanners 202, 216, 222, 228. While the example of FIG. 2 shows four computing devices 201, 214, 220, 226 each having a single scanner for a total of four scanners 202, 216, 222, 228, this is for example purposes only, as the system 200 may include fewer or greater quantities of computing devices 201, 214, 220, 226 and associated scanners 202, 216, 222, 228. Further, while the example of FIG. 2 shows one scanner 202, 216, 222, 228 per computing device 201, 214, 220, 226, this is also for example purposes only as one or more of the computing devices 201, 214, 220, 226 may include a plurality of scanners 202, 216, 222, 228. For example, the number of scanners 202, 216, 222, 228 included in the zone 232 or in each zone of the area being monitored may be greater than or equal to the number of advertising channels available on the wireless protocol being monitored by the scanners 202, 216, 222, 228. For example, as the Bluetooth or BLE communications protocol includes three advertising channels, the zone 232 may include three or more scanners 202, 216, 222, 228 in order to be able to monitor each advertising channel for signals during the same time period (e.g., a scan window). For example, each of the scanners 202, 216, 222, 228 may be Bluetooth or BLE scanners. For example, each of the Bluetooth or BLE scanners 202, 216, 222, 228 may be configured as a Bluetooth or BLE system on a chip (SOC). Each scanner 202, 216, 222, 228 may include a receiver or transceiver for receiving or receiving and transmitting data, such as the signals and the data associated with the signals. Each scanner 202, 216, 222, 228 may be configured to monitor the same or different channels as each other scanner 202, 216, 222, 228. For example, each scanner 202, 216, 222, 228 may be configured to receive signals from a different wireless tag 242a-n simultaneously or at substantially the same time on the same or different channel of the wireless protocol during the same period of time (e.g., during the same scan window).

While only shown as part of the computing device 201 of FIG. 2, each of the computing devices 201, 214, 220, 226 may comprise a motion analyzer module 204. The motion analyzer module 204 may be configured to determine if a device 240a-n, associated with a wireless tag 242a-n from which a signal is received, is in motion. For example, the motion analyzer module 204 may determine if the device 240a-n is in motion based on motion data included in the received signal from one of the wireless tags 242a-n. The motion data may be any form of data that indicates whether the wireless tag 242a-n and the associated device 240a-n are in motion or are not in motion (e.g., immobile). The motion data may comprise data received from an accelerometer, velocity meter, or other motion-sensing device associated with a particular wireless tag 242a-n. The motion data may comprise a quantity of acceleration, a quantity of velocity, or an indication of motion (e.g., in motion, not in motion) for the particular wireless tag 242a-n and the associated device 240a-n to which the tag is coupled.

For example, the motion analyzer module 204 may determine if the device 240a-n is in motion based on motion data derived from the received signal received by one of the scanners 202, 216, 222, 228 from one of the wireless tags 242a-n. For example, one of the computing devices 201, 214, 220, 226 (or the associated scanner 202, 216, 222, 228 that received the signal) may determine the RSSI quantity or value for the received signal. The motion analyzer module 204, may compare the RSSI quantity for the received signal to a second RSSI quantity of another signal from the same wireless tag 242a-n associated with the same device 240a-n that sent the received signal. For example, the another signal may be the most recent prior signal received by the same computing device 201, 214, 220, 226 (e.g., by the same scanner 202, 216, 222, 228) from the particular wireless tag 242a-n as the received signal. The motion analyzer module 204 may retrieve the second RSSI quantity from the device information database 208 or another storage medium based on the device ID associated with the received signal. The motion analyzer module 204 may determine, based on the comparison, that the particular wireless tag 242a-n and associated device 240a-n is in motion based on a difference between the first RSSI quantity and the second RSSI quantity. For example, one of the computing devices 201, 214, 220, 226 may determine that the device 240a-n is in motion based on a difference between the first RSSI quantity and the second RSSI quantity satisfying a RSSI threshold.

While only shown as part of the computing device 201 of FIG. 2, each of the computing devices 201, 214, 220, 226 may comprise a location analyzer module 206. The location analyzer module 206 may be configured to determine the location of one or more of the devices 240a-n. The location analyzer module 206 may be configured to determine the location of each device within the zone 130 of an area. Each zone may be a room, a portion of the room, a plurality of rooms, a portion of a floor, or the floor of a building, or a portion of an outdoor area. For example, the location analyzer module 206 may determine the location of a device 240a-n based on the received signal from the wireless tag 242a-n associated with the particular device 240a-n. For example, the location analyzer module 206, may determine the scanner 202, 216, 222, 228 that received the signal. The location analyzer module 206 may determine the location of the scanner 202, 216, 222, 228 receiving the signal. For example, the scanner location may be stored in the device information database 210 or another storage medium and may be accessed based on the scanner identifier for the particular scanner 202, 216, 222, 228. The location analyzer module 204 may determine the location of the device 240a-n based on the location of the scanner and the RSSI for the received signal at the particular scanner 202, 216, 222, 228 or time difference of arrival (TDoA) for the signal.

For example, one of the computing devices 201, 214, 220, 226 may determine the location of the device 240a-n based on multiple signals received from the wireless tag 242a-n associated with the device 240a-n and the RSSI or TDoA for each of those signals. For example, one of the computing devices 201, 214, 220, 226 may determine the location based on triangulation of at least a portion of multiple signals (e.g., including the signal) from the wireless tag 242a-n using the RSSI or TDoA for each of those signals or other known techniques. For example, the signal may be received by the first scanner 202, a second signal, from the same wireless tag 242a-n associated with the same first device 240a-n as the signal, may be received at the second scanner 216, and a third signal, from the same wireless tag 242a-n associated with the same first device 240a-n as the signal and the second signal, may be received by the third scanner 222. The location analyzer module 206 may determine the location of the device 240a-n based on the received signal, second signal, and third signal and the RSSI or TDoA of each of the signal, second signal, and third signal. For example, the location analyzer module 206 may determine the location of the device 240a-n based on the known location of one or more of the computing devices 201, 214, 220, 226 (e.g., stored in the device information database 208 or another storage medium and triangulation of the signal, second signal, and third signal, and the RSSI or TDoA of each signal.

While only shown as part of the computing device 201 of FIG. 2, each of the computing devices 201, 214, 220, 226 may comprise a device information database 208. The device information database 208 may be any form of database or memory storage and may be within or communicatively coupled to the particular computing device 201, 214, 220, 226. The device information database 208 may comprise data record entries or tables of data associated with determining the location of the plurality of devices 240a-n. For example, the device information database 208 may include the signal or signal data (e.g., the device ID, the capabilities of the wireless tag 242a-n sending the signal, the functionality of the wireless tag 242a-n sending the signal, and/or the intention of the wireless tag sending the signal), motion data for the wireless tag 242a-n and associated device 240a-n, the RSSI for each signal, the scanner identifier identifying the scanner 202, 216, 222, 228 that received each signal from the particular wireless tag 242a-n, the location of each computing device 201, 214, 220, 226, and/or each scanner 202, 216, 222, 228 within each zone (e.g., zone 232) and/or the determined location of each device 240a-n and/or wireless scanner 242a-n within each zone.

The system 200 may comprise a remote computing device 256. The remote computing device 256 may be positioned at a location away from the area (e.g. one or more zones, such as zone 232) being monitored. The remote computing device 256 may be a personal computer, computing station, workstation, portable computer, laptop computer, a network computer, a server or cloud computing device, and so on.

One or more of the computing devices 201, 214, 220, 226 (e.g., each computing device) may be configured to provide data associated with the received plurality of signals via a wired or a wireless network connection, such as the network 254, to a remote computing device 256. For example, one or more of the computing devices 201, 214, 220, 226 may send data associated with the plurality of signals to the remote computing device 256 via long-term evolution (LTE), long range wide area network (LoRaWAN), narrowband internet of things (NB-IoT), Wi-Fi, ZigBee Bluetooth, BLE, SigFox, Ethernet, or via any other wired or wireless network.

In examples where one of the computing devices 201, 214, 220, 226 determines the location of the plurality of devices 240a-n based on the received signal(s), the data may comprise location data for one or more devices 240a-n, and a device ID identifying the particular device 240a-n in that location. The data may also include an identifier of the computing device 201, 214, 220, 226 and/or the scanner 202, 216, 222, 228 that received the signal for the particular device 240a-n. The data may also include an indication whether each particular device 240a-n is determined to be mobile or not in motion (e.g., immobile).

In examples where the remote computing device 256 is configured to determine the location of the plurality of devices 240a-n based on received signals at one or more of the computing devices 201, 214, 220, 226, the data may comprise, the signal or signal data (e.g., the device ID, the capabilities of the wireless tag 242a-n sending the signal, the functionality of the wireless tag 242a-n sending the signal, and/or the intention of the wireless tag sending the signal), motion data for the wireless tag 242a-n and associated device 240a-n, the RSSI for the signal, the scanner identifier identifying the scanner 202, 216, 222, 228 that received the signal from the particular wireless tag 242a-n.

The remote computing device 256 may include a motion analyzer module and location analyzer module that operate in substantially the same manner as that described of the motion analyzer module 204 and the location analyzer module 206 of the computing devices 201, 214, 220, 226. The remote computing device 256 may also include a device information database for storing all or a portion of one or more of the signal data, the RSSI for each signal, the motion data, the zone identifier, the scanner identifier, the area identifier, the determined motion status for a device 240a-n, or the determined location for each device of the plurality of devices 240a-n, the location of each computing device 201, 214, 220, 226 and/or each scanner 202, 216, 222, 228 within each zone (e.g., zone 232) and/or the determined location of each device 240a-n and/or wireless scanner 242a-n within each zone.

The system 200 may comprise the plurality of devices 240a-n. A portion of the plurality of devices 240a-n may be located within a first zone 232 of an area being monitored. Other portions of the plurality of devices 240a-n may be located within another zone of a plurality of zones within the area being monitored. Each device of the plurality of devices 240a-n may be not in motion (e.g., immobile or stationary) at certain times and moving at other times. Any device of the plurality of devices 240a-n may be moved from one part of a zone to another part of the zone, from one zone to another zone, or from a zone to another area that may or may not be monitored. The device 240a-n may be one or more of a device, a part, a piece of equipment, a computing device, machinery, a tool, a provision, material, an asset or the like. While the example of FIG. 2 shows four devices 240a-n, this is for example purposes only as the quantity of devices 240a-n in the area being monitored and/or within a particular zone (e.g., zone 232) can be in the tens, hundreds, or even thousands of devices 240a-n.

The system 200 may comprise a plurality of wireless tags 242a-n. Each wireless tag 242a-n may be associated with a corresponding one of the devices 240a-n, such that each device 240a-n may have an individual wireless tag 242a-n associated with the device 240a-n. Each wireless tag 242a-n may be configured to send a wireless signal according to a wireless protocol. For example, the wireless protocol may be any one of Bluetooth, BLE, Wi-Fi, ZigBee, UWB, CAN bus, RS485, NFC, or LoRa. For example, the signal may be an advertising signal transmitted on an advertising channel of the particular wireless protocol. For example, the signal may be a Bluetooth or BLE advertising signal transmitted on one of Bluetooth or BLE channels 37-39. For example, the signal may comprise a data packet. The data packet may comprise an advertising packet header and a packet body. The signal (e.g., the data packet) may include a device identifier (ID), the capabilities of the wireless tag, the functionality of the wireless tag, the intention of the wireless tag, and/or motion data.

While only shown with regard to the first wireless tag 242a of FIG. 2, each wireless tag 242a-n may comprise one or more of a circuit board 244, a power source 246, or a transmitter 248. For example, the circuit board 244 may be a printed circuit board or any other type of circuit board. For example, the power source 246 may be a battery. For example, the transmitter 248 may be a transmitter or a transceiver.

Each wireless tag 242a-n may comprise an accelerometer 250, velocity meter, or other motion-sensing device for indicating motion. For example, the accelerometer 250, velocity meter, or other motion sensing device may be coupled to or incorporated into and communicatively coupled with the wireless tag 242a-n. The accelerometer 250, velocity meter, or other motion-sensing device may be configured to generate motion data. The motion data may comprise a quantity of acceleration, a quantity of velocity, or an indication of motion (e.g., in motion, not in motion) for the particular wireless tag 242a-n and the associated device 240a-n to which the tag is coupled. The motion data may be provided by the accelerometer 250, velocity meter, or other motion-sensing device to the wireless tag 242a-n that the accelerometer 250, velocity meter, or other motion-sensing device is coupled or communicatively coupled to. For example, the wireless tag 242a-n may include the motion data in or append the motion data to the advertising packet of the signal. For example, the wireless tag 242a-n may evaluate the motion data and determine whether to send (e.g., broadcast) the advertising signal based on the motion data. For example, the wireless tag 242a-n may send the signal if motion data indicates that the wireless tag 242a-n (and thus the corresponding device 240a-n) is not in motion (e.g., at rest or immobile), and may not send the signal if the motion data indicates that the wireless tag 242a-n (and thus the corresponding device 240a-n) is in motion. While the example of FIG. 2 shows four wireless tags 242a-n, this is for example purposes only, as the quantity of wireless tags 242a-n in the area being monitored and/or within a particular zone (e.g., zone 232) can be in the tens, hundreds, or even thousands to correspond with the quantity of devices 240a-n for which the location is being monitored.

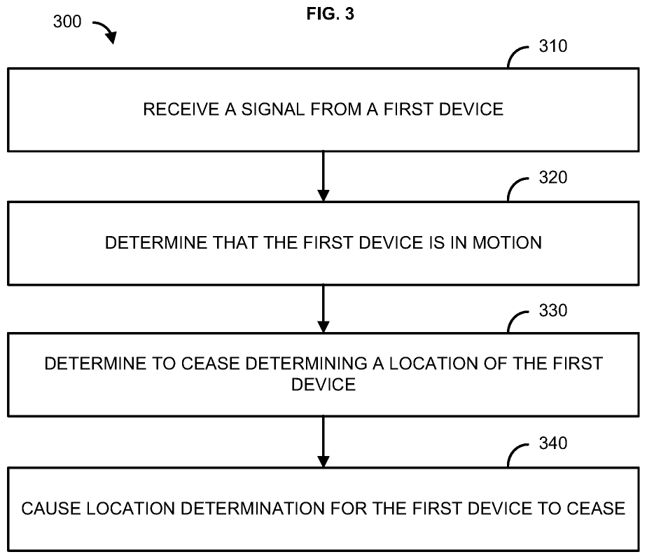

FIG. 3 is a flowchart showing an example method 300 for managing device location determination for one or more devices (e.g., devices 120a-n, 240a-n). The method 300 may be completed by a computing device (e.g., the computing device 101, one or more of the computing devices 201, 214, 220, or 226, the remote computing device 134, 256 or any other computing device). Further, the method 300 describes example communications between computing devices or portions of a computing device. While the example communications show direct communications between one computing device and another, this is for example purposes only, as networks (e.g., network 132, 254) or other computing devices not shown, may be intermediary devices along a communication path between one or more of the communications between the computing devices shown.

At 310, a signal from a first device may be received. For example, the signal may be received by one of the channel scanners 102, 104, 106 of the computing device 101 or one of the channel scanners 202, 216, 222, 228 of one of the corresponding computing devices 201, 214, 220, 226. For example, the signal may be received by one of the antennas of the particular computing device 101, 201, 214, 220, 226. The signal may be sent by one of the wireless tags 122a-n, 242a-n associated with the respective first device 120a-n, 240a-n. The signal may be sent for a predetermined time period (e.g., the advertising interval). The advertising interval may be anywhere in the range of about 20 milliseconds to about 10.5 seconds.

The signal may be a wireless signal. For example, the signal may be any one of a Bluetooth signal, a BLE signal, a Wi-Fi signal, a ZigBee signal, an ultra-wide band (UWB) signal, a controller area network (CAN) bus signal, an RS485 signal, a near-field communication (NFC) signal, or a LoRa signal. For example, the signal may be an advertising signal transmitted on an advertising channel of the particular wireless transmission protocol. For example, the signal may be a Bluetooth or BLE advertising signal transmitted on one of Bluetooth or BLE channels 37-39. For example, the signal may comprise a data packet. The data packet may comprise an advertising packet header and a packet body. The signal (e.g., the data packet) may include a device identifier (ID), the capabilities of the wireless tag, the functionality of the wireless tag, and/or the intention of the wireless tag. The device ID may identify the sending tag 122a-n, 242a-n and/or the associated device 120a-n, 240a-n to which the particular tag is connected. The capabilities data of the wireless tag 122a-n, 242a-n may include whether the wireless tag 122a-n, 242a-n is a connectible or non-connectible device and/or the low energy features supported by the wireless tag 122a-n, 242a-n. The functionality data of the wireless tag 122a-n, 242a-n may include transmit power level, service data, the type of advertising device, an advertising interval, and/or a uniform resource identifier. The intention data of the wireless tag 122a-n, 242a-n may include whether the tag intends to communicatively connect to the computing device (e.g., the computing device 101) or if the wireless tag 122a-n, 242a-n intends to not connect but instead transmit information (e.g., broadcast) to the computing device 101. For example, the wireless tag 122a-n, 242a-n may operate in broadcast mode and not intend to connect to the computing device 101 but simply transmit data to the computing device 101.

The data packet of the signal or another portion of the signal may also include motion data. The motion data may be any form of data that indicates whether the wireless tag 122a-n, 242a-n and the associated device 120a-n, 240a-n are in motion or are not in motion (e.g., immobile). The motion data may be data received from an accelerometer (e.g., accelerometer 130, 250), velocity meter, or other motion-sensing device associated with a particular wireless tag 122a-n, 242a-n. For example, the accelerometer 130, 250, velocity meter, or other motion-sensing device may be coupled to or incorporated into and communicatively coupled with the particular wireless tag 122a-n, 242a-n. The motion data may comprise a quantity of acceleration, a quantity of velocity, or an indication of motion (e.g., in motion, not in motion) for the particular wireless tag 122a-n, 242a-n and the associated device 120a-n, 240a-n to which the tag is coupled.

At 320, the first device (e.g., one of the first devices 120a-n, 240a-n) may be determined to be in motion. For example, the determination may be made by a computing device, such as one of the computing device 101, 201. For example, the determination may be made by the motion analyzer 108, 204 of the computing device 101, 201. The determination that the first device 120a-n, 240a-n is in motion may be based on the signal.

For example, the determination that the first device 120a-n, 240a-n is in motion may be based on the motion data in the signal. For example, the determination that the first device 120a-n, 240a-n is in motion may be based on the quantity of acceleration, quantity of velocity, or the indication that the tag is in motion for the particular wireless tag 122a-n, 242a-n. For example, the determination that the first device 120a-n, 240a-n is in motion may be based on the quantity of acceleration or the quantity of velocity satisfying (e.g., greater than or greater than or equal to) a motion threshold.

For example, the determination that the first device 120a-n, 240a-n is in motion may be based on a first signal strength of the signal received by the computing device 101, 201. For example, the computing device 101, 201 may determine the first signal strength of the signal. For example, the computing device 101, 201 (or the associated scanner 102, 104, 106, 202) may determine the first received signal strength indicator (RSSI) quantity or value for the received signal. The computing device 101, 201, may compare the first RSSI quantity for the received signal to a second RSSI quantity of another signal from the same wireless tag 122a-n, 242a-n associated with the same first device 120a-n, 240a-n that sent the received signal. For example, the another signal may be the most recent prior signal received from the particular wireless tag 122a-n, 242a-n at the same computing device 101, 201, 214, 220, 226, as the received signal. The computing device 101, 201 may determine, based on the comparison, that the wireless tag 122a-n, 242a-n and associated first device 120a-n, 240a-n is in motion. For example, the computing device 101, 201 may determine that the first device 120a-n, 240a-n is in motion based on a difference between the first RSSI quantity and the second RSSI quantity. For example, the computing device 101, 201 may determine that the first device 120a-n, 240a-n is in motion based on a difference between the first RSSI quantity and the second RSSI quantity satisfying a RSSI threshold.

At 330, it may be determined to cease determining a location of the first device (e.g., one of the first devices 120a-n, 240a-n). For example, determining to cease determining the location of the first device 120a-n, 240a-n, may be determined by the computing device 101, 201. For example, determining to cease determining the location of the first device 120a-n, 240a-n may be based on the first device 120a-n, 240a-n being in motion. First devices 120a-n, 240a-n, such as equipment, tools, products, and the like may be positioned throughout an area. When the first devices 120a-n, 240a-n are moving or in use, it may not be necessary to determine the location of the first device 120a-n, 240a-n. By not determining the location of the first device 120a-n, 240a-n when it is in motion, computing resources may be conserved for determining the location of the other devices 120a-n, 240a-n.

At 340, location determination for the first device (e.g., first device 120a-n, 240a-n may be caused to cease or stop. For example, the computing device 101, 201 may cause the location determination for the first device 120a-n, 240a-n to cease. For example, the computing device 101, 201 may cease determining the location of the particular first device 120a-n, 240a-n until it is determined (e.g., by the computing device 101, 201) that the first device 120a-n, 240a-n is no longer in motion. For example, the computing device 101, 201, may signal the location analyzer 110, 206 to cease determining the location of the first device 120a-n, 240a-n.

For example, ceasing location determination while devices are in motion can save computing resource, as the computing devices will not need to be determining the location of those devices while they are in motion. Further, ceasing location determination while devices are in motion may also save battery power and extend battery life for the devices and/or the wireless tags associated with devices that are in motion. For example, the devices and/or wireless tags associated with the devices that are in motion may be instructed to cease sending signals while the device is in motion, thereby reducing battery usage of the device and/or wireless tag associated with sending the signal, and extending the battery life. For example, ceasing location determination while devices are in motion can also reduce interference and transmission collisions cased when multiple (e.g., tens, hundreds, thousands) of devices and/or wireless tags are attempting to send signals so that their positions may be determined. In a crowded communications network, reducing even a small number of devices and/or wireless tags from transmitting while the device is in motion, can help improve the ability of other devices and/or wireless tags to get their communications through to the computing devices.

In certain examples, one or more of determining the first device 120a-n, 240a-n is in motion, determining to cease determination of the location of the first device 120a-n, 240a-n, or causing location determination for the first device 120a-n, 240a-n to cease, may be all or partially completed by a remote computing device 134, 256. For example, the computing device 101, 201, may cause location determination to cease for the particular first device 120a-n, 240a-n by sending a message to the remote computing device 134, 256. The message may indicate the device ID for the wireless tag 122a-n, 242a-n and/or first device 120a-n, 240a-n and an indication that the particular first device 120a-n, 240a-n is in motion.

The first device 120a-n, 240a-n that was previously in motion, may subsequently be determined to not be in motion (e.g., immobile or at rest), and location determination for that first device 120a-n, 240a-n may resume. For example, a subsequent second signal from the wireless tag 122a-n, 242a-n associated with the first device 120a-n, 240a-n may be received by one of the channel scanners 102, 104, 106 of the computing device 101 or one of the channel scanners 202, 216, 222, 228 of one of the corresponding computing devices 201, 214, 220, 226. The second signal may be constructed substantially the same as the signal. The second signal may indicate that the first device 120a-n, 240a-n is not in motion (e.g., immobile). For example, the second signal may include second motion data received from the accelerometer (e.g., accelerometer 130, 250), velocity meter, or other motion-sensing device associated with the particular wireless tag 122a-n, 242a-n and indicating that the wireless tag 122a-n, 242a-n and the associated device 120a-n, 240a-n are not in motion (e.g., immobile or at rest).

The computing device 101, 201 may determine that the first device 120a-n, 240a-n is not in motion (e.g., immobile). For example, the determination may be made by the computing device 101, 201 (e.g., motion analyzer) based on the second motion data in the second signal. For example, the determination that the first device 120a-n, 240a-n is not in motion (e.g., immobile) may be based on the quantity of acceleration, quantity of velocity, or the indication that the tag is in motion for the particular wireless tag 122a-n, 242a-n. For example, the determination that the first device 120a-n, 240a-n is not in motion (e.g., immobile) may be based on the quantity of acceleration or the quantity of velocity not satisfying (e.g., less than or less than or equal to) a motion threshold.

The computing device 101, 201 may cause location determination for the first device 120a-n, 240a-n to resume. For example, the computing device 101, 201, (e.g., the location analyzer 110, 206) may determine the location of the first device based on the first device 120a-n, 240a-n not being in motion (e.g., immobile). For example, the computing device 101, 201 may determine the location of the first device 120a-n, 240a-n based on the received second signal. For example, the location analyzer 110, 206 may determine the scanner 102, 104, 106, 202, 216, 222, 228 that received the second signal. The location analyzer 110, 206 may determine the location of the scanner 102, 104, 106, 202, 216, 222, 228 receiving the second signal. For example, the scanner location may be stored in the device information database 112, 208 or another storage medium and may be accessed based on the scanner identifier for the particular scanner 102, 104, 106, 202, 216, 222, 228. The location analyzer 110, 206 may determine the location of the first device 120a-n, 240a-n based on the location of the scanner and the RSSI for the received second signal at the particular scanner 104, 106, 202, 216, 222, 228 or time difference of arrival (TDoA) for the second signal.

For example, the computing device 101, 201 may determine the location of the first device 120a-n, 240a-n based on multiple signals received from the wireless tag 122a-n, 142a-n associated with the first device 120a-n, 140a-n and the RSSI or TDoA for each of those signals. For example, the computing device 101, 201 may determine the location based on triangulation of at least a portion of multiple signals, (e.g., including the second signal) from the wireless tag 122a-n, 142a-n using the RSSI or TDoA for each of those signals or other known techniques.

The computing device 101 may determine the location of the first device 120a-n based on receiving multiple signals at the computing device 101. For example, the second signal may be received by the first scanner 102 of the computing device 101. The computing device 101 may receive a third signal, from the same wireless tag 122a-n associated with the same first device 120a-n as the second signal, at a second scanner 104. The computing device 101 may receive the fourth signal, from the same wireless tag 122a-n associated with the same first device 120a-n as the second and third signal, at a third scanner 106. For example, the second, third, and fourth signals may be received on the same or different channels of the wireless protocol. For example, each of the second, third, and fourth signals may indicate that the first device 120a-n is not in motion (e.g., immobile). The computing device 101 (e.g., the location analyzer 110) may determine the location of the first device 120a-n based on the received second signal, third signal, and fourth signal and the RSSI or TDoA of each of the second signal, third signal, and fourth signal. For example, the location analyzer 110 may determine the location of the first device 120a-n based on triangulation of the second signal, third signal, and fourth signal, the RSSI or TDoA of each signal and the known location of the computing device 101 (e.g., stored in the device information database 112 or another storage medium).

The computing device 201 may determine the location of the first device 240a-n based on receiving multiple signals at multiple computing devices (e.g., computing devices 201, 216, 222, 228). For example, the second signal may be received by a first scanner 202 of the computing device 201. A computing device 214 may receive a third signal, from the same wireless tag 242a-n associated with the same first device 240a-n as the second signal, at the second scanner 216. The third signal or the data associated with the third signal may be sent or otherwise transmitted by the computing device 214 to the computing device 201 to be stored in the device information database 208 and to be used by the location analyzer 206 to determine the location of the first device 240a-n. A computing device 220 may receive a fourth signal, from the same wireless tag 242a-n associated with the same first device 240a-n as the second signal and third signal, at the third scanner 222. The fourth signal or the data associated with the fourth signal may be sent or otherwise transmitted by the computing device 220 to the computing device 201 to be stored in the device information database 208 and to be used by the location analyzer 206 to determine the location of the first device 240a-n. The second, third, and fourth signals may be received on the same or different channels of the wireless protocol. For example, each of the second, third, and fourth signals may indicate that the first device 240a-n is not in motion (e.g., immobile). The computing device 201 (e.g., the location analyzer 206) may determine the location of the first device 240a-n based on the received second signal, third signal, and fourth signal. For example, the location analyzer 206 may determine the location of the first device 240a-n based on triangulation of the second signal, third signal, and fourth signal, the RSSI or TDoA of each signal and the known locations of the computing device 201, computing device 214, and computing device 220 (e.g., stored in the device information database 208 or another storage medium).

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n.

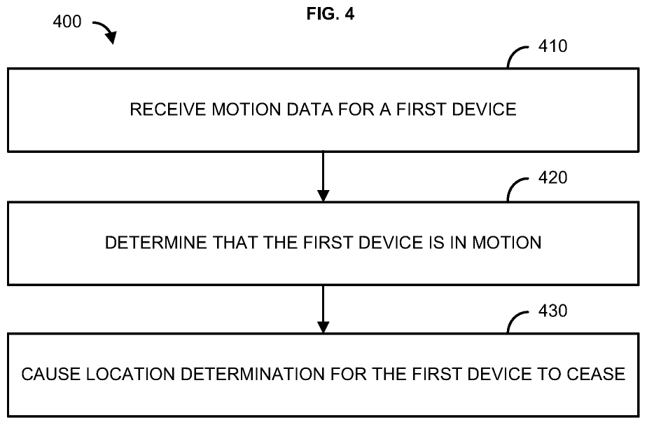

FIG. 4 is a flowchart showing another example method 400 for managing device location determination for one or more devices (e.g., devices 120a-n, 240a-n). The method 400 may be completed by a computing device (e.g., the computing device 101, one or more of the computing devices 201, 214, 220, or 226, the remote computing device 134, 256 or any other computing device).

At 410, motion data for a first device may be received. For example, the motion data may be received by one of the channel scanners 102, 104, 106 of the computing device 101 or one of the channel scanners 202, 216, 222, 228 of one of the corresponding computing devices 201, 214, 220, 226. The motion data may be sent by one of the wireless tags 122a-n, 242a-n associated with the respective first device 120a-n, 240a-n.

The motion data may be sent as part of a wireless signal. For example, the signal may be any one of a Bluetooth signal, a BLE signal, a Wi-Fi signal, a ZigBee signal, UWB signal, a CAN bus signal, an RS485 signal, a NFC signal, or a LoRa signal. For example, the signal may be an advertising signal transmitted on an advertising channel of the particular wireless transmission protocol. For example, the signal may be a Bluetooth or BLE advertising signal transmitted on one of Bluetooth or BLE channels 37-39. The signal may comprises a data packet that includes an advertising packet header and a packet body. The packet of the signal may include a device ID, the capabilities of the wireless tag, the functionality of the wireless tag, and/or the intention of the wireless tag.

The motion data may be included in the packet body of the data packet. The motion data may be any form of data that indicates whether the wireless tag 122a-n, 242a-n and the associated device 120a-n, 240a-n are in motion or not in motion (e.g., immobile). The motion data may be data received from an accelerometer (e.g., accelerometer 130, 250), velocity meter, or other motion-sensing device coupled to or incorporated into and communicatively coupled with the particular wireless tag 122a-n, 242a-n. The motion data may comprise a quantity of acceleration, a quantity of velocity, or an indication of motion (e.g., in motion, not in motion) for the particular wireless tag 122a-n, 242a-n and the associated device 120a-n, 240a-n to which the tag is coupled.

At 420, a determination may be made that the first device (e.g., one of the first devices 120a-n, 240a-n) is in motion. For example, the determination may be made by one of the computing devices 101, 201 (e.g., the motion analyzer 108, 204). The determination that the first device 120a-n, 240a-n is in motion may be based on the motion data.

For example, the determination that the first device 120a-n, 240a-n is in motion may be based on the quantity of acceleration (e.g., a non-zero quantity), quantity of velocity (e.g., a non-zero quantity), or the indication that the tag is in motion for the particular wireless tag 122a-n, 242a-n. For example, the determination that the first device 120a-n, 240a-n is in motion may be based on the quantity of acceleration or the quantity of velocity satisfying (e.g., greater than or greater than or equal to) a motion threshold.

At 430, location determination for the first device (e.g., first device 120a-n, 240a-n may be caused to cease or stop. For example, the computing device 101, 201 may cause the location determination for the first device 120a-n, 240a-n to cease. For example, the computing device 101, 201 may cease determining the location of the particular first device 120a-n, 240a-n until it is determined (e.g., by the computing device 101, 201) that the first device 120a-n, 240a-n is no longer in motion. For example, the computing device 101, 201, may signal the location analyzer 110, 206 to cease determining the location of the first device 120a-n, 240a-n.

In certain examples, one or more of determining the first device 120a-n, 240a-n is in motion or causing location determination for the first device 120a-n, 240a-n to cease, may be all or partially completed by a remote computing device 134, 256. For example, the computing device 101, 201, may cause location determination to cease for the particular first device 120a-n, 240a-n by sending a message to the remote computing device 134, 256. The message may indicate the device ID for the wireless tag 122a-n, 242a-n and/or first device 120a-n, 240a-n and an indication that the particular first device 120a-n, 240a-n is in motion.

The first device 120a-n, 240a-n that was previously in motion, may subsequently be determined to not be in motion (e.g., immobile or at rest), and location determination for that first device 120a-n, 240a-n may resume. For example, subsequent second motion data from the wireless tag 122a-n, 242a-n associated with the first device 120a-n, 240a-n may be received by one of the channel scanners 102, 104, 106 of the computing device 101 or one of the channel scanners 202, 216, 222, 228 of one of the corresponding computing devices 201, 214, 220, 226. The second motion data may indicate that the first device 120a-n, 240a-n is not in motion (e.g., immobile). For example, the second motion data may comprise data received from the accelerometer (e.g., accelerometer 130, 250), velocity meter, or other motion-sensing device associated with the particular wireless tag 122a-n, 242a-n and indicating that the wireless tag 122a-n, 242a-n and the associated device 120a-n, 240a-n are not moving (e.g., immobile or at rest).

The computing device 101, 201 may determine that the first device 120a-n, 240a-n is not in motion (e.g., immobile) based on the second motion data in a second signal (e.g., a second advertising signal). For example, the determination that the first device 120a-n, 240a-n is not in motion (e.g., immobile) may be based on the quantity of acceleration, quantity of velocity, or the indication that the tag is in motion for the particular wireless tag 122a-n, 242a-n. For example, the determination that the first device 120a-n, 240a-n is not in motion (e.g., immobile) may be based on the quantity of acceleration or the quantity of velocity not satisfying (e.g., less than or less than or equal to) the motion threshold.

The computing device 101, 201 may cause location determination for the first device 120a-n, 240a-n to resume. For example, the computing device 101, 201, (e.g., the location analyzer 110, 206) may determine the location of the first device based on the first device 120a-n, 240a-n not being in motion (e.g., immobile). For example, the computing device 101, 201 may determine the location of the first device based on multiple signals received from the wireless tag 122a-n, 142a-n associated with the first device 120a-n, 140a-n, For example, the computing device 101, 201 may determine the location based on triangulation of at least a portion of multiple signals, (e.g., including the second signal) from the wireless tag 122a-n, 142a-n or other known techniques.

The computing device 101 may determine the location of the first device 120a-n based on receiving multiple signals at the computing device 101. For example, the second signal may be received by the first scanner 102 of the computing device 101. The computing device 101 may receive a third signal, from the same wireless tag 122a-n associated with the same first device 120a-n as the second signal, at the second scanner 104. The computing device 101 may receive a fourth signal, from the same wireless tag 122a-n associated with the same first device 120a-n as the second and third signal, at the third scanner 106. For example, the second, third, and fourth signals may be received on the same or different channels of the wireless protocol. For example, each of the second, third, and fourth signals may indicate that the first device 120a-n is not in motion (e.g., immobile). The computing device 101 (e.g., the location analyzer 110) may determine the location of the first device 120a-n based on the received second signal, third signal, and fourth signal.

The computing device 201 may determine the location of the first device 240a-n based on receiving multiple signals at multiple computing devices (e.g., computing devices 201, 216, 222, 228). For example, the second signal may be received by the first scanner 202 of the computing device 201. The computing device 214 may receive a third signal, from the same wireless tag 242a-n associated with the same first device 240a-n as the second signal, at the second scanner 216. The third signal or the data associated with the third signal may be sent or otherwise transmitted by the computing device 214 to the computing device 201 to be stored in the device information database 208 and to be used by the location analyzer 206 to determine the location of the first device 240a-n. The computing device 220 may receive a fourth signal, from the same wireless tag 242a-n associated with the same first device 240a-n as the second and third signal, at the third scanner 222. The fourth signal or the data associated with the fourth signal may be sent or otherwise transmitted by the computing device 220 to the computing device 201 to be stored in the device information database 208 and to be used by the location analyzer 206 to determine the location of the first device 240a-n. The second, third, and fourth signals may be received on the same or different channels of the wireless protocol. For example, each of the second, third, and fourth signals may indicate that the first device 240a-n is not in motion (e.g., immobile). The computing device 201 (e.g., the location analyzer 206) may determine the location of the first device 240a-n based on the received second signal, third signal, and fourth signal.

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n.

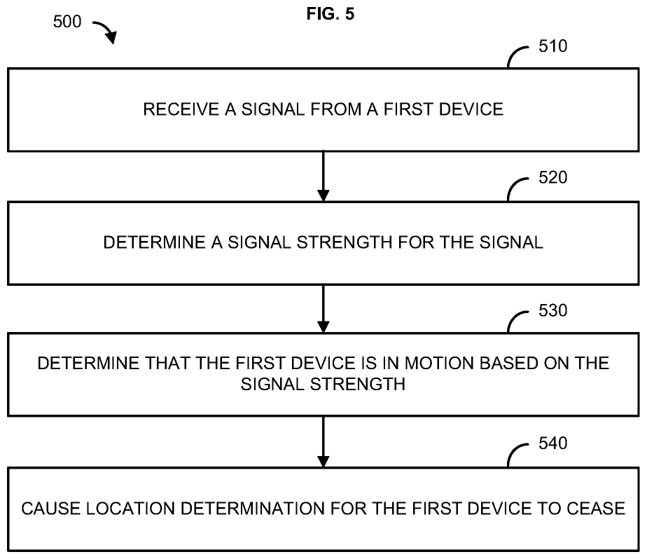

FIG. 5 is a flowchart showing another example method 500 for managing device location determination for one or more devices (e.g., devices 120a-n, 240a-n). The method 500 may be completed by a computing device (e.g., the computing device 101, one or more of the computing devices 201, 214, 220, or 226, the remote computing device 134, 256 or any other computing device).

At 510, a signal from a first device may be received. For example, the signal may be received by one of the channel scanners 102, 104, 106 of the computing device 101 or one of the channel scanners 202, 216, 222, 228 of one of the corresponding computing devices 201, 214, 220, 226. The signal may be sent by one of the wireless tags 122a-n, 242a-n associated with the respective first device 120a-n, 240a-n. The signal may be a wireless signal, such as any one of a Bluetooth signal, a BLE signal, a Wi-Fi signal, a ZigBee signal, UWB signal, a CAN bus signal, an RS485 signal, a NFC signal, or a LoRa signal. For example, the signal may be an advertising signal transmitted on an advertising channel of the particular wireless transmission protocol. For example, the signal may be a Bluetooth advertising signal transmitted on one of Bluetooth channels 37-39.

The signal may comprise a data packet. The data packet may comprise an advertising packet header and a packet body. The signal (e.g., the data packet) may include a device ID, the capabilities of the wireless tag, the functionality of the wireless tag, and/or the intention of the wireless tag. The device ID may identify the sending tag 122a-n, 242a-n and/or the associated device 120a-n, 240a-n to which the particular tag is connected.

At 520, the signal strength of the signal may be determined. For example, the determination may be made by a computing device, such as one of the computing device 101, 201. The determination of the signal strength may be based on the signal received by the computing device 101, 201. For example, the computing device 101, 201 may determine the first RSSI quantity or value for the received signal.

At 530, a determination may be made that the first device (e.g., the first device 120a-n, 240a-n) is in motion. The determination that the first device 120a-n, 240a-n is in motion may be made by the computing device 101, 201 (e.g., the motion analyzer 108, 204). For example, the determination that the first device 120a-n, 240a-n is in motion may be based on a first signal strength of the signal received by the computing device 101, 201.

The computing device 101, 201, may compare the first RSSI quantity for the received signal to a second RSSI quantity of another signal from the same wireless tag 122a-n, 242a-n associated with the same first device 120a-n, 240a-n that sent the received signal. For example, the another signal may be the most recent prior signal received from the particular wireless tag 122a-n, 242a-n at the same computing device 101, 201, 214, 220, 226, as the received signal. The computing device 101, 201 may determine, based on the comparison, that the wireless tag 122a-n, 242a-n and associated first device 120a-n, 240a-n is in motion. For example, the computing device 101, 201 may determine that the first device 120a-n, 240a-n is in motion based on a difference between the first RSSI quantity and the second RSSI quantity. For example, the computing device 101, 201 may determine that the first device 120a-n, 240a-n is in motion based on a difference between the first RSSI quantity and the second RSSI quantity satisfying a RSSI threshold.

At 540, location determination for the first device (e.g., first device 120a-n, 240a-n may be caused to cease or stop. For example, the computing device 101, 201 may cause the location determination for the first device 120a-n, 240a-n to cease based on the determination that the first device 120a-n, 240a-n is in motion. For example, the computing device 101, 201 may cease determining the location of the particular first device 120a-n, 240a-n until it is determined (e.g., by the computing device 101, 201) that the first device 120a-n, 240a-n is no longer in motion. For example, the computing device 101, 201, may signal the location analyzer 110, 206 to cease determining the location of the first device 120a-n, 240a-n.

In certain examples, one or more of determining the signal strength for the signal, determining that the first device 120a-n, 240a-n is in motion, or causing location determination for the first device 120a-n, 240a-n to cease, may be all or partially completed by a remote computing device 134, 256. For example, the computing device 101, 201, may cause location determination to cease for the particular first device 120a-n, 240a-n by sending a message to the remote computing device 134, 256 via one or more of the networks 132, 254, or another network. The message may indicate the device ID for the wireless tag 122a-n, 242a-n and/or first device 120a-n, 240a-n and an indication that the particular first device 120a-n, 240a-n is in motion.

The first device 120a-n, 240a-n that was previously in motion, may subsequently be determined to be immobile or at rest, and location determination for that first device 120a-n, 240a-n may resume. For example, a subsequent second signal from the wireless tag 122a-n, 242a-n associated with the first device 120a-n, 240a-n may be received by one of the channel scanners 102, 104, 106 of the computing device 101 or one of the channel scanners 202, 216, 222, 228 of one of the corresponding computing devices 201, 214, 220, 226. The second signal may be constructed substantially the same as the signal. The second signal may indicate that the first device 120a-n, 240a-n is immobile. For example, the computing device 101, 201, may determine an RSSI for the second signal, The computing device 101, 201 may compare the RSSI for the second signal to the first RSSI for the signal and determine they are the same or the difference between the RSSI for the second signal and the first RSSI for the signal satisfies (e.g., is less than or less than or equal to) an RSSI threshold. In other examples, it may take the computing device 101, 201 receiving multiple signals from the particular wireless tag 122a-n, 242a-n associated with the particular first device 120a-n, 240a-n before a pair of consecutive RSSIs is the same or within the RSSI threshold and the first device 120a-n, 240a-n is determined to be immobile.

The computing device 101, 201 may cause location determination for the first device 120a-n, 240a-n to resume. For example, the computing device 101, 201, (e.g., the location analyzer 110, 206) may determine the location of the first device based on the first device 120a-n, 240a-n not being in motion (e.g., immobile). For example, the computing device 101, 201 may determine the location of the first device based on multiple signals received from the wireless tag 122a-n, 142a-n associated with the first device 120a-n, 140a-n, For example, the computing device 101, 201 may determine the location based on triangulation of at least a portion of multiple signals, (e.g., including the second signal) from the wireless tag 122a-n, 142a-n or other known techniques.

The computing device 101 may determine the location of the first device 120a-n based on receiving multiple signals at the computing device 101. For example, the second signal may be received by the first scanner 102 of the computing device 101. The computing device 101 may receive a third signal, from the same wireless tag 122a-n associated with the same first device 120a-n as the second signal, at the second scanner 104. The computing device 101 may receive a fourth signal, from the same wireless tag 122a-n associated with the same first device 120a-n as the second and third signal, at the third scanner 106. For example, the second, third, and fourth signals may be received on the same or different channels of the wireless protocol. For example, the RSSIs for one or more of the second, third, and fourth signals may indicate that the first device 120a-n is not in motion (e.g., immobile). The computing device 101 (e.g., the location analyzer 110) may determine the location of the first device 120a-n based on the received second signal, third signal, and fourth signal.

The computing device 201 may determine the location of the first device 240a-n based on receiving multiple signals at multiple computing devices (e.g., computing devices 201, 216, 222, 228). For example, the second signal may be received by the first scanner 202 of the computing device 201. The computing device 214 may receive a third signal, from the same wireless tag 242a-n associated with the same first device 240a-n as the second signal, at the second scanner 216. The third signal or the data associated with the third signal may be sent or otherwise transmitted by the computing device 214 to the computing device 201 to be stored in the device information database 208 and to be used by the location analyzer 206 to determine the location of the first device 240a-n. The computing device 220 may receive a fourth signal, from the same wireless tag 242a-n associated with the same first device 240a-n as the second and third signal, at the third scanner 222. The fourth signal or the data associated with the fourth signal may be sent or otherwise transmitted by the computing device 220 to the computing device 201 to be stored in the device information database 208 and to be used by the location analyzer 206 to determine the location of the first device 240a-n. The second, third, and fourth signals may be received on the same or different channels of the wireless protocol. For example the RSSIs for one or more of the second, third, and fourth signals may indicate that the first device 240a-n is not in motion (e.g., immobile). The computing device 201 (e.g., the location analyzer 206) may determine the location of the first device 240a-n based on the received second signal, third signal, and fourth signal.

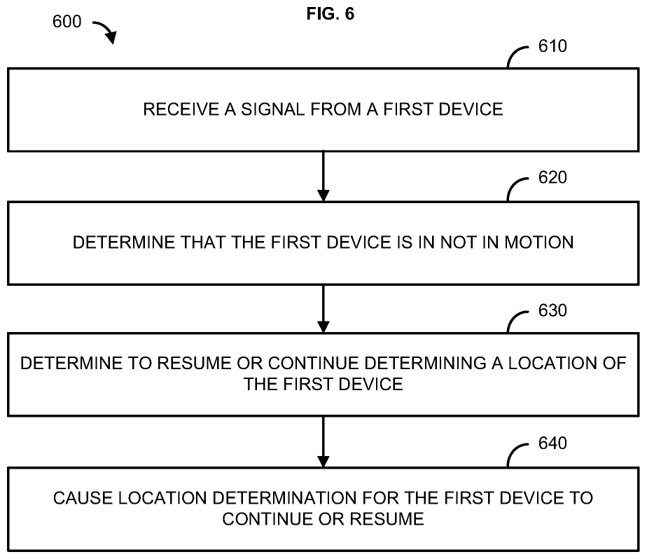

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n. FIG. 6 is a flowchart showing an example method 600 for managing device location determination for one or more devices (e.g., devices 120a-n, 240a-n). The method 600 may be completed by a computing device (e.g., the computing device 101, one or more of the computing devices 201, 214, 220, or 226, the remote computing device 134, 256 or any other computing device). Further, the method 600 describes example communications between computing devices or portions of a computing device. While the example communications show direct communications between one computing device and another computing device, this is for example purposes only, as networks (e.g., network 132, 254) or other computing devices not shown, may be intermediary devices along a communication path between one or more of the communications between the computing devices shown.

At 610, a signal from a first device may be received. For example, the signal may be received by one of the channel scanners 102, 104, 106 of the computing device 101 or one of the channel scanners 202, 216, 222, 228 of one of the corresponding computing devices 201, 214, 220, 226. For example, the signal may be received by one of the antennas of the particular computing device 101, 201, 214, 220, 226. The signal may be sent by one of the wireless tags 122a-n, 242a-n associated with the respective first device 120a-n, 240a-n. The signal may be sent for a predetermined time period (e.g., the advertising interval). The advertising interval may be anywhere in the range of about 20 milliseconds to about 10.5 seconds.

The signal may be a wireless signal. For example, the signal may be any one of a Bluetooth signal, a BLE signal, a Wi-Fi signal, a ZigBee signal, an ultra-wide band (UWB) signal, a controller area network (CAN) bus signal, an RS485 signal, a near-field communication (NFC) signal, or a LoRa signal. For example, the signal may be an advertising signal transmitted on an advertising channel of the particular wireless transmission protocol. For example, the signal may be a Bluetooth or BLE advertising signal transmitted on one of Bluetooth or BLE channels 37-39. For example, the signal may comprise a data packet. The data packet may comprise an advertising packet header and a packet body. The signal (e.g., the data packet) may include a device identifier (ID), the capabilities of the wireless tag, the functionality of the wireless tag, and/or the intention of the wireless tag. The device ID may identify the sending tag 122a-n, 242a-n and/or the associated device 120a-n, 240a-n to which the particular tag is connected. The capabilities data of the wireless tag 122a-n, 242a-n may include whether the wireless tag 122a-n, 242a-n is a connectible or non-connectible device and/or the low energy features supported by the wireless tag 122a-n, 242a-n. The functionality data of the wireless tag 122a-n, 242a-n may include transmit power level, service data, the type of advertising device, an advertising interval, and/or a uniform resource identifier. The intention data of the wireless tag 122a-n, 242a-n may include whether the tag intends to communicatively connect to the computing device (e.g., the computing device 101) or if the wireless tag 122a-n, 242a-n intends to not connect but instead transmit information (e.g., broadcast) to the computing device 101. For example, the wireless tag 122a-n, 242a-n may operate in broadcast mode and not intend to connect to the computing device 101 but simply transmit data to the computing device 101.

The data packet of the signal or another portion of the signal may also include motion data. The motion data may be any form of data that indicates whether the wireless tag 122a-n, 242a-n and the associated device 120a-n, 240a-n are in motion or are not in motion (e.g., immobile). The motion data may be data received from an accelerometer (e.g., accelerometer 130, 250), velocity meter, or other motion-sensing device associated with a particular wireless tag 122a-n, 242a-n. For example, the accelerometer 130, 250, velocity meter, or other motion-sensing device may be coupled to or incorporated into and communicatively coupled with the particular wireless tag 122a-n, 242a-n. The motion data may comprise a quantity of acceleration, a quantity of velocity, or an indication of motion (e.g., in motion, not in motion) for the particular wireless tag 122a-n, 242a-n and the associated device 120a-n, 240a-n to which the tag is coupled.

At 620, the first device (e.g., one of the first devices 120a-n, 240a-n) may be determined to not be in motion (e.g., immobile). For example, the determination may be made by a computing device, such as one of the computing device 101, 201. For example, the determination may be made by the motion analyzer 108, 204 of the computing device 101, 201. The determination that the first device 120a-n, 240a-n is not in motion may be based on the signal.

For example, the determination that the first device 120a-n, 240a-n is not in motion may be based on the motion data in the signal. For example, the determination that the first device 120a-n, 240a-n is not in motion may be based on the quantity of acceleration, quantity of velocity, or the indication that the tag is not in motion for the particular wireless tag 122a-n, 242a-n. For example, the determination that the first device 120a-n, 240a-n is not in motion may be based on the quantity of acceleration or the quantity of velocity satisfying (e.g., greater than or greater than or equal to) a motion threshold.

For example, the determination that the first device 120a-n, 240a-n is not in motion may be based on a first signal strength of the signal received by the computing device 101, 201. For example, the computing device 101, 201 may determine the first signal strength of the signal. For example, the computing device 101, 201 (or the associated scanner 102, 104, 106, 202) may determine the first received signal strength indicator (RSSI) quantity or value for the received signal. The computing device 101, 201, may compare the first RSSI quantity for the received signal to a second RSSI quantity of another signal from the same wireless tag 122a-n, 242a-n associated with the same first device 120a-n, 240a-n that sent the received signal. For example, the another signal may be the most recent prior signal received from the particular wireless tag 122a-n, 242a-n at the same computing device 101, 201, 214, 220, 226, as the received signal. The computing device 101, 201 may determine, based on the comparison, that the wireless tag 122a-n, 242a-n and associated first device 120a-n, 240a-n is not in motion. For example, the computing device 101, 201 may determine that the first device 120a-n, 240a-n is not in motion based on the first RSSI quantity and the second RSSI quantity being the same or substantially the same or based on a difference between the first RSSI quantity and the second RSSI quantity being less than or less than or equal to the RSSI threshold. For example, the computing device 101, 201 may determine that the first device 120a-n, 240a-n is not in motion based on a difference between the first RSSI quantity and the second RSSI quantity not satisfying the RSSI threshold.

At 630, it may be determined to begin, resume, or continue determining a location of the first device (e.g., one of the first devices 120a-n, 240a-n). For example, determining to begin, continue, or resume determining the location of the first device 120a-n, 240a-n, may be determined by the computing device 101, 201. For example, determining to begin, continue, or resume determining the location of the first device 120a-n, 240a-n may be based on the first device 120a-n, 240a-n not being in motion (e.g., immobile).

At 640, location determination for the first device (e.g., first device 120a-n, 240a-n may be caused to begin, continue, or resume. For example, the computing device 101, 201 may cause the location determination for the first device 120a-n, 240a-n to continue, begin or resume. For example, the computing device 101, 201 may begin, continue, or resume determining the location of the particular first device 120a-n, 240a-n until it is determined (e.g., by the computing device 101, 201) that the first device 120a-n, 240a-n is in motion. For example, the computing device 101, 201, may signal the location analyzer 110, 206 to begin, continue, or resume determining the location of the first device 120a-n, 240a-n.

In certain examples, one or more of determining the first device 120a-n, 240a-n is in not in motion (e.g., immobile), determining to begin, continue, or resume determination of the location of the first device 120a-n, 240a-n, or causing location determination for the first device 120a-n, 240a-n to begin, resume, or continue, may be all or partially completed by a remote computing device 134, 256. For example, the computing device 101, 201, may cause location determination to begin, continue, or resume for the particular first device 120a-n, 240a-n by sending a message to the remote computing device 134, 256. The message may indicate the device ID for the wireless tag 122a-n, 242a-n and/or first device 120a-n, 240a-n and an indication that the particular first device 120a-n, 240a-n is not in motion.

For example, the computing device 101, 201 may determine the location of the first device 120a-n, 240a-n based on the received signal. For example, the location analyzer 110, 206 may determine the scanner 102, 104, 106, 202, 216, 222, 228 that received the signal. The location analyzer 110, 206 may determine the location of the scanner 102, 104, 106, 202, 216, 222, 228 receiving the signal. For example, the scanner location may be stored in the device information database 112, 208 or another storage medium and may be accessed based on the scanner identifier for the particular scanner 102, 104, 106, 202, 216, 222, 228. The location analyzer 110, 206 may determine the location of the first device 120a-n, 240a-n based on the location of the scanner and the RSSI for the received second signal at the particular scanner 104, 106, 202, 216, 222, 228 or time difference of arrival (TDoA) for the signal.

For example, the computing device 101, 201 may determine the location of the first device 120a-n, 240a-n based on multiple signals received from the wireless tag 122a-n, 142a-n associated with the first device 120a-n, 140a-n and the RSSI or TDoA for each of those signals. For example, the computing device 101, 201 may determine the location based on triangulation of at least a portion of multiple signals, (e.g., including the second signal) from the wireless tag 122a-n, 142a-n using the RSSI or TDoA for each of those signals or other known techniques.

The computing device 101 may determine the location of the first device 120a-n based on receiving multiple signals at the computing device 101. For example, the signal may be received by the first scanner 102 of the computing device 101. The computing device 101 may receive a second signal, from the same wireless tag 122a-n associated with the same first device 120a-n as the signal, at a second scanner 104. The computing device 101 may receive the third signal, from the same wireless tag 122a-n associated with the same first device 120a-n as the signal and the second signal, at a third scanner 106. For example, the signal and the second and third signals may be received on the same or different channels of the wireless protocol. For example, each of the signal and the second and third signals may indicate that the first device 120a-n is not in motion (e.g., immobile or at rest). The computing device 101 (e.g., the location analyzer 110) may determine the location of the first device 120a-n based on the received signal and the second signal and third signal and the RSSI or TDoA of each of the signal, second signal, and third signal. For example, the location analyzer 110 may determine the location of the first device 120a-n based on triangulation of the signal, second signal, and third signal, the RSSI or TDoA of each signal and the known location of the computing device 101 (e.g., stored in the device information database 112 or another storage medium).

The computing device 201 may determine the location of the first device 240a-n based on receiving multiple signals at multiple computing devices (e.g., computing devices 201, 216, 222, 228). For example, the signal may be received by a first scanner 202 of the computing device 201. A computing device 214 may receive a second signal, from the same wireless tag 242a-n associated with the same first device 240a-n as the signal, at the second scanner 216. The second signal or the data associated with the second signal may be sent or otherwise transmitted by the computing device 214 to the computing device 201 to be stored in the device information database 208 and to be used by the location analyzer 206 to determine the location of the first device 240a-n. A computing device 220 may receive a third signal, from the same wireless tag 242a-n associated with the same first device 240a-n as the signal and the second signal, at the third scanner 222. The third signal or the data associated with the third signal may be sent or otherwise transmitted by the computing device 220 to the computing device 201 to be stored in the device information database 208 and to be used by the location analyzer 206 to determine the location of the first device 240a-n. The signal and second and third signals may be received on the same or different channels of the wireless protocol. For example, each of the signal and the second and third signals may indicate that the first device 240a-n is not in motion (e.g., immobile or at rest). The computing device 201 (e.g., the location analyzer 206) may determine the location of the first device 240a-n based on the received signal, second signal, and third signal. For example, the location analyzer 206 may determine the location of the first device 240a-n based on triangulation of the signal, second signal, and third signal, the RSSI or TDoA of each signal and the known locations of the computing device 201, computing device 214, and computing device 220 (e.g., stored in the device information database 208 or another storage medium).

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n.

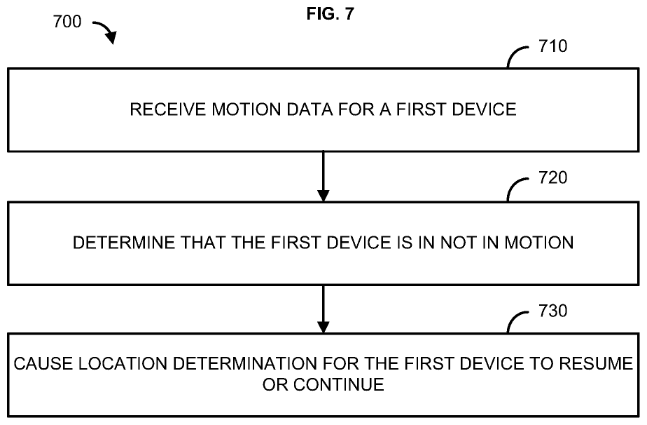

FIG. 7 is a flowchart showing another example method 700 for managing device location determination for one or more devices (e.g., devices 120a-n, 240a-n). The method 700 may be completed by a computing device (e.g., the computing device 101, one or more of the computing devices 201, 214, 220, or 226, the remote computing device 134, 256 or any other computing device).

At 710, motion data for a first device may be received. For example, the motion data may be received by one of the channel scanners 102, 104, 106 of the computing device 101 or one of the channel scanners 202, 216, 222, 228 of one of the corresponding computing devices 201, 214, 220, 226. The motion data may be sent by one of the wireless tags 122a-n, 242a-n associated with the respective first device 120a-n, 240a-n.

The motion data may be sent as part of a wireless signal. For example, the signal may be any one of a Bluetooth signal, a BLE signal, a Wi-Fi signal, a ZigBee signal, UWB signal, a CAN bus signal, an RS485 signal, a NFC signal, or a LoRa signal. For example, the signal may be an advertising signal transmitted on an advertising channel of the particular wireless transmission protocol. For example, the signal may be a Bluetooth or BLE advertising signal transmitted on one of Bluetooth or BLE channels 37-39. The signal may comprises a data packet that includes an advertising packet header and a packet body. The packet of the signal may include a device ID, the capabilities of the wireless tag, the functionality of the wireless tag, and/or the intention of the wireless tag.

The motion data may be included in the packet body of the data packet. The motion data may be any form of data that indicates whether the wireless tag 122a-n, 242a-n and the associated device 120a-n, 240a-n are in motion or not in motion (e.g., immobile or at rest). The motion data may be data received from an accelerometer (e.g., accelerometer 130, 250), velocity meter, or other motion-sensing device coupled to or incorporated into and communicatively coupled with the particular wireless tag 122a-n, 242a-n. The motion data may comprise a quantity of acceleration, a quantity of velocity, or an indication of motion (e.g., in motion, not in motion) for the particular wireless tag 122a-n, 242a-n and the associated device 120a-n, 240a-n to which the tag is coupled.

At 720, a determination may be made that the first device (e.g., one of the first devices 120a-n, 240a-n) is not in motion (e.g., immobile or at rest). For example, the determination may be made by one of the computing devices 101, 201 (e.g., the motion analyzer 108, 204). The determination that the first device 120a-n, 240a-n is not in motion may be based on the motion data.

For example, the determination that the first device 120a-n, 240a-n is not in motion (e.g., immobile or at rest) may be based on the quantity of acceleration (e.g., a non-zero quantity), quantity of velocity (e.g., a non-zero quantity), or the indication that the tag is in motion for the particular wireless tag 122a-n, 242a-n. For example, the determination that the first device 120a-n, 240a-n is not in motion may be based on the quantity of acceleration or the quantity of velocity being zero or substantially zero or not satisfying (e.g., less than or less than or equal to) a motion threshold.

At 730, location determination for the first device (e.g., first device 120a-n, 240a-n may be caused to begin, continue, or resume. For example, the computing device 101, 201 may cause the location determination for the first device 120a-n, 240a-n to begin, continue, or resume. For example, the computing device 101, 201 may begin, continue, or resume (e.g., after previously ceasing as described in FIGS. 3-5) determining the location of the particular first device 120a-n, 240a-n until, for example, it is determined (e.g., by the computing device 101, 201) that the first device 120a-n, 240a-n is in motion. For example, the computing device 101, 201, may signal the location analyzer 110, 206 to begin, continue, or resume determining the location of the first device 120a-n, 240a-n.

In certain examples, one or more of determining the first device 120a-n, 240a-n is not in motion or causing location determination for the first device 120a-n, 240a-n to begin, continue, or resume, may be all or partially completed by a remote computing device 134, 256. For example, the computing device 101, 201, may cause location determination to begin, continue, or resume for the particular first device 120a-n, 240a-n by sending a message to the remote computing device 134, 256. The message may indicate the device ID for the wireless tag 122a-n, 242a-n and/or first device 120a-n, 240a-n and an indication that the particular first device 120a-n, 240a-n is not in motion (e.g., immobile or at rest).

The computing device 101, 201 may cause location determination for the first device 120a-n, 240a-n to begin, continue, or resume. For example, the computing device 101, 201, (e.g., the location analyzer 110, 206) may determine the location of the first device based on the first device 120a-n, 240a-n not being in motion (e.g., immobile). For example, the computing device 101, 201 may determine the location of the first device based on multiple signals received from the wireless tag 122a-n, 142a-n associated with the first device 120a-n, 140a-n, For example, the computing device 101, 201 may determine the location based on triangulation of at least a portion of multiple signals, (e.g., including the signal) from the wireless tag 122a-n, 142a-n or other known techniques.

The computing device 101 may determine the location of the first device 120a-n based on receiving multiple signals at the computing device 101. For example, the signal may be received by the first scanner 102 of the computing device 101. The computing device 101 may receive a second signal, from the same wireless tag 122a-n associated with the same first device 120a-n as the signal, at the second scanner 104. The computing device 101 may receive a third signal, from the same wireless tag 122a-n associated with the same first device 120a-n as the signal and second signal, at the third scanner 106. For example, the signal and second and third signals may be received on the same or different channels of the wireless protocol. For example, each of the signal and second and third signals may indicate that the first device 120a-n is not in motion (e.g., immobile). The computing device 101 (e.g., the location analyzer 110) may determine the location of the first device 120a-n based on the received signal, second signal, and third signal.

The computing device 201 may determine the location of the first device 240a-n based on receiving multiple signals at multiple computing devices (e.g., computing devices 201, 216, 222, 228). For example, the signal may be received by the first scanner 202 of the computing device 201. The computing device 214 may receive a second signal, from the same wireless tag 242a-n associated with the same first device 240a-n as the signal, at the second scanner 216. The second signal or the data associated with the second signal may be sent or otherwise transmitted by the computing device 214 to the computing device 201 to be stored in the device information database 208 and to be used by the location analyzer 206 to determine the location of the first device 240a-n. The computing device 220 may receive a third signal, from the same wireless tag 242a-n associated with the same first device 240a-n as the signal and second signal, at the third scanner 222. The third signal or the data associated with the third signal may be sent or otherwise transmitted by the computing device 220 to the computing device 201 to be stored in the device information database 208 and to be used by the location analyzer 206 to determine the location of the first device 240a-n. The signal and second and third signals may be received on the same or different channels of the wireless protocol. For example, each of the signal and second and third signals may indicate that the first device 240a-n is not in motion (e.g., immobile or at rest). The computing device 201 (e.g., the location analyzer 206) may determine the location of the first device 240a-n based on the received signal, second signal, and third signal.

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n.

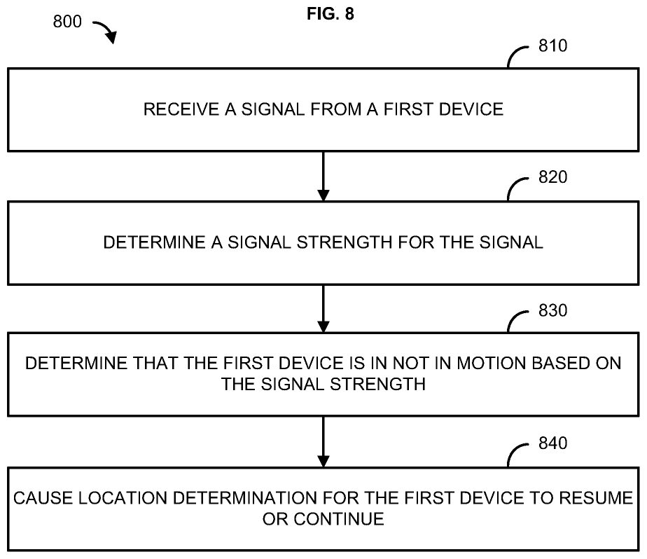

FIG. 8 is a flowchart showing another example method 800 for managing device location determination for one or more devices (e.g., devices 120a-n, 240a-n). The method 800 may be completed by a computing device (e.g., the computing device 101, one or more of the computing devices 201, 214, 220, or 226, the remote computing device 134, 256 or any other computing device).

At 810, a signal from a first device may be received. For example, the signal may be received by one of the channel scanners 102, 104, 106 of the computing device 101 or one of the channel scanners 202, 216, 222, 228 of one of the corresponding computing devices 201, 214, 220, 226. The signal may be sent by one of the wireless tags 122a-n, 242a-n associated with the respective first device 120a-n, 240a-n. The signal may be a wireless signal, such as any one of a Bluetooth signal, a BLE signal, a Wi-Fi signal, a ZigBee signal, UWB signal, a CAN bus signal, an RS485 signal, a NFC signal, or a LoRa signal. For example, the signal may be an advertising signal transmitted on an advertising channel of the particular wireless transmission protocol. For example, the signal may be a Bluetooth advertising signal transmitted on one of Bluetooth channels 37-39.

The signal may comprise a data packet. The data packet may comprise an advertising packet header and a packet body. The signal (e.g., the data packet) may include a device ID, the capabilities of the wireless tag, the functionality of the wireless tag, and/or the intention of the wireless tag. The device ID may identify the sending tag 122a-n, 242a-n and/or the associated device 120a-n, 240a-n to which the particular tag is connected.

At 820, the signal strength of the signal may be determined. For example, the determination may be made by a computing device, such as one of the computing device 101, 201. The determination of the signal strength may be based on the signal received by the computing device 101, 201. For example, the computing device 101, 201 may determine the first RSSI quantity or value for the received signal.

At 830, a determination may be made that the first device (e.g., the first device 120a-n, 240a-n) is not in motion (e.g., immobile or at rest). The determination that the first device 120a-n, 240a-n is not in motion may be made by the computing device 101, 201 (e.g., the motion analyzer 108, 204). For example, the determination that the first device 120a-n, 240a-n is not in motion may be based on a first signal strength of the signal received by the computing device 101, 201.

The computing device 101, 201, may compare the first RSSI quantity for the received signal to a second RSSI quantity of another signal from the same wireless tag 122a-n, 242a-n associated with the same first device 120a-n, 240a-n that sent the received signal. For example, the another signal may be the most recent prior signal received from the particular wireless tag 122a-n, 242a-n at the same computing device 101, 201, 214, 220, 226, as the received signal. The computing device 101, 201 may determine, based on the comparison, that the wireless tag 122a-n, 242a-n and associated first device 120a-n, 240a-n is not in motion. For example, the computing device 101, 201 may determine that the first device 120a-n, 240a-n is not in motion based on a difference between the first RSSI quantity and the second RSSI quantity. For example, the computing device 101, 201 may determine that the first device 120a-n, 240a-n is not in motion based on the first RSSI quantity and the second RSSI quantity being equal or substantially equal or based on a difference between the first RSSI quantity and the second RSSI quantity satisfying a RSSI threshold that indicates the first device 120a-n, 240a-n is not in motion (e.g., immobile or at rest).

At 840, location determination for the first device (e.g., first device 120a-n, 240a-n may be caused to begin, continue, or resume. For example, the computing device 101, 201 may cause the location determination for the first device 120a-n, 240a-n to begin, continue, or resume based on the determination that the first device 120a-n, 240a-n is not in motion. For example, the computing device 101, 201 may begin, continue, or resume determining the location of the particular first device 120a-n, 240a-n until, for example, it is determined (e.g., by the computing device 101, 201) that the first device 120a-n, 240a-n is in motion. For example, the computing device 101, 201, may signal the location analyzer 110, 206 to begin, continue, or resume determining the location of the first device 120a-n, 240a-n.

In certain examples, one or more of determining the signal strength for the signal, determining that the first device 120a-n, 240a-n is not in motion, or causing location determination for the first device 120a-n, 240a-n to begin, continue, or resume, may be all or partially completed by a remote computing device 134, 256. For example, the computing device 101, 201, may cause location determination to begin, continue, or resume for the particular first device 120a-n, 240a-n by sending a message to the remote computing device 134, 256 via one or more of the networks 132, 254, or another network. The message may indicate the device ID for the wireless tag 122a-n, 242a-n and/or first device 120a-n, 240a-n and an indication that the particular first device 120a-n, 240a-n is not in motion.

For example, the computing device 101, 201, (e.g., the location analyzer 110, 206) may determine the location of the first device based on the first device 120a-n, 240a-n not being in motion (e.g., immobile or at rest). For example, the computing device 101, 201 may determine the location of the first device based on multiple signals received from the wireless tag 122a-n, 142a-n associated with the first device 120a-n, 140a-n, For example, the computing device 101, 201 may determine the location based on triangulation of at least a portion of multiple signals, (e.g., including the signal) from the wireless tag 122a-n, 142a-n or other known techniques.

The computing device 101 may determine the location of the first device 120a-n based on receiving multiple signals at the computing device 101. For example, the signal may be received by the first scanner 102 of the computing device 101. The computing device 101 may receive a second signal, from the same wireless tag 122a-n associated with the same first device 120a-n as the signal, at the second scanner 104. The computing device 101 may receive a third signal, from the same wireless tag 122a-n associated with the same first device 120a-n as the signal and second signal, at the third scanner 106. For example, the signal and second and third signals may be received on the same or different channels of the wireless protocol. For example, the RSSIs for one or more of the second, and second and third signals may indicate that the first device 120a-n is not in motion (e.g., immobile). The computing device 101 (e.g., the location analyzer 110) may determine the location of the first device 120a-n based on the received signal, second signal, and third signal.

The computing device 201 may determine the location of the first device 240a-n based on receiving multiple signals at multiple computing devices (e.g., computing devices 201, 216, 222, 228). For example, the signal may be received by the first scanner 202 of the computing device 201. The computing device 214 may receive a second signal, from the same wireless tag 242a-n associated with the same first device 240a-n as the signal, at the second scanner 216. The second signal or the data associated with the second signal may be sent or otherwise transmitted by the computing device 214 to the computing device 201 to be stored in the device information database 208 and to be used by the location analyzer 206 to determine the location of the first device 240a-n. The computing device 220 may receive a third signal, from the same wireless tag 242a-n associated with the same first device 240a-n as the signal and second signal, at the third scanner 222. The third signal or the data associated with the third signal may be sent or otherwise transmitted by the computing device 220 to the computing device 201 to be stored in the device information database 208 and to be used by the location analyzer 206 to determine the location of the first device 240a-n. The signal and second and third signals may be received on the same or different channels of the wireless protocol. For example the RSSIs for one or more of the signal and second and third signals may indicate that the first device 240a-n is not in motion (e.g., immobile). The computing device 201 (e.g., the location analyzer 206) may determine the location of the first device 240a-n based on the received signal, second signal, and third signal.

The computing device 101, 201 may store the location of the first device 120a-n, 240a-n. For example, the computing device 101, 201, may store the location information for the first device 120a-n, 240a-n in the device information database 112. For example, the computing device 101, 202 may send or otherwise transmit the location information for the first device 120a-n, 240a-n to the remote computing device 134, 256, via the network 132, 254 or another network. The location information may be sent with the device ID for the wireless tag 122a-n, 242a-n and/or the device ID for the associated first device 120a-n, 240a-n. The remote computing device 134, 256 may store the location information for the first device 120a-n, 240a-n in a data record associated with the device ID for the wireless tag 122a-n, 242a-n and/or the device ID for the associated first device 120a-n, 240a-n.

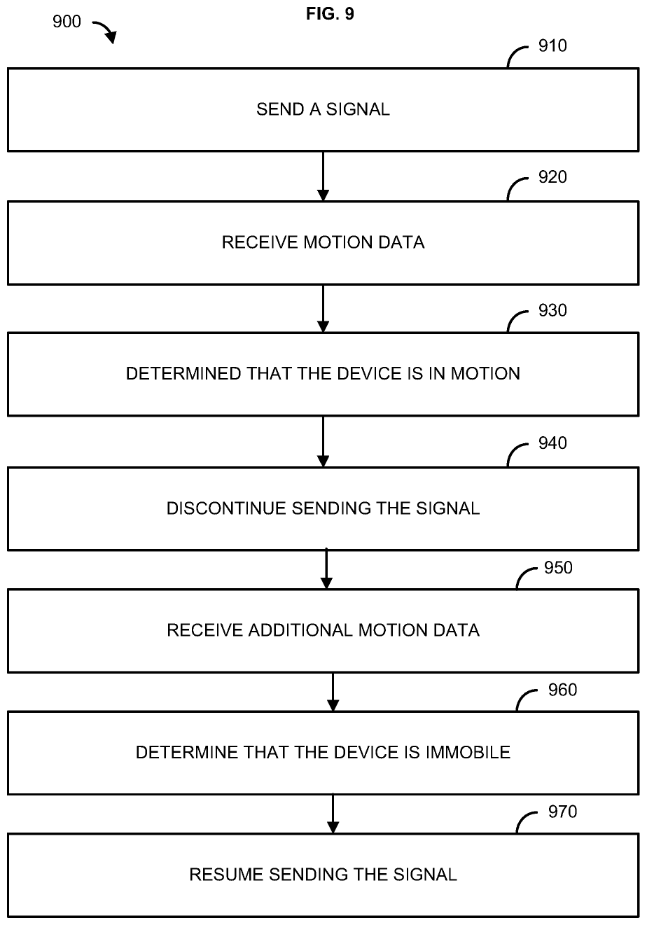

FIG. 9 is a flowchart showing an example method 900 for managing the sending of signals for determining device location for one or more devices (e.g., devices 120a-n, 240a-n). The method 900 may be completed by a wireless device (e.g., the wireless tag 122a-n, 242a-n or any other computing device).

At 910, a signal may be sent or otherwise transmitted. For example, the signal may be sent by a wireless tag 122a-n, 242a-n and received by a computing device (e.g., any one of the computing device 101, 201, 214, 220, 226). For example, the signal may be sent to one of the channel scanners 102, 104, 106 of the computing device 101 or one of the channel scanners 202, 216, 222, 228 of one of the corresponding computing devices 201, 214, 220, 226. The signal may be sent by the wireless tag 122a-n, 242a-n periodically, randomly, or a combination of a periodic time period plus a random additional time period.

The signal may be a wireless signal. For example, the signal may be any one of a Bluetooth signal, a BLE signal, a Wi-Fi signal, a ZigBee signal, UWB signal, a CAN bus signal, an RS485 signal, a NFC signal, or a LoRa signal. For example, the signal may be an advertising signal transmitted on an advertising channel of the particular wireless transmission protocol. For example, the signal may be a Bluetooth advertising signal transmitted on one of Bluetooth channels 37-39.

At 920, motion data may be received or determined. For example, the motion data may be received or determined by the wireless tag 122a-n, 242a-n from the accelerometer 130, 250, velocity meter, or other motion-sensing device associated with the wireless tag 122a-n, 242a-n. The accelerometer 130, 250, velocity meter, or other motion-sensing device may be coupled to or incorporated into and/or communicatively coupled with the particular wireless tag 122a-n, 242a-n. The motion data may be any form of data that indicates whether the wireless tag 122a-n, 242a-n and the associated device 120a-n, 240a-n are in motion or not in motion (e.g., immobile), such as a quantity of acceleration, a quantity of velocity, or an indication of motion (e.g., a signal the tag is in motion or a signal the tag is not in motion).

At 930, the device (e.g., one of the devices 120a-n, 240a-n) may be determined to be in motion. For example, the determination may be made by the wireless tag 122a-n, 242a-n associated with the particular device 120a-n, 240a-n. The determination that the device 120a-n, 240a-n is in motion may be based on the received or determined motion data. For example, the determination that the device 120a-n, 240a-n is in motion may be based on the quantity of acceleration (e.g., a non-zero quantity), quantity of velocity (e.g., a non-zero quantity), or the indication that the tag is in motion for the particular wireless tag 122a-n, 242a-n within the motion data. For example, the determination that the first device 120a-n, 240a-n is in motion may be based on the quantity of acceleration or the quantity of velocity satisfying (e.g., greater than or greater than or equal to) a motion threshold.

At 940, the sending or transmission of the signal may be discontinued. The wireless tag 122a-n, 242a-n may discontinue the sending (e.g., broadcast) of the signal to the computing devices 101, 201, 214, 220, 226. For example, the sending of the signal may be discontinued based on the determination that the device is in motion. For example, the sending of the signal may be discontinued until the wireless tag 122a-n, 242a-n determines that the device 120a-n, 240a-n, based on the motion data, is no longer moving (e.g., immobile or at rest).

At 950, additional motion data is received or determined. For example, the additional motion data is received or determined by the wireless tag 122a-n, 242a-n from the accelerometer 130, 250, velocity meter, or other motion-sensing device associated with the wireless tag 122a-n, 242a-n.

At 960, the device (e.g., one of the devices 120a-n, 240a-n) may be determined to not in motion (e.g., immobile or at rest). For example, the determination may be made by the wireless tag 122a-n, 242a-n associated with the particular device 120a-n, 240a-n. The determination that the device 120a-n, 240a-n is not in motion (e.g., immobile) may be based on the received or determined additional motion data. For example, the determination that the device 120a-n, 240a-n is not in motion (e.g., immobile) may be based on the quantity of acceleration (e.g., a zero quantity), quantity of velocity (e.g., a zero quantity), or the indication that the tag is in not in motion for the particular wireless tag 122a-n, 242a-n within the motion data. For example, the determination that the first device 120a-n, 240a-n is not in motion (e.g., immobile) may be based on the quantity of acceleration or the quantity of velocity not satisfying (e.g., less than or less than or equal to) a motion threshold.

At 970, sending or otherwise transmitting the signal is resumed. For example, the wireless tag 122a-n, 242a-n may resume sending (e.g., broadcasting) the signal to one or more of the computing devices 101, 201, 214, 220, 226. For example, the sending of the signal may be resumed based on the determination that the device 120a-n, 240a-n associated with the wireless tag 122a-n, 242a-n is not in motion. The signal may be sent by the wireless tag 122a-n, 242a-n periodically, randomly, or a combination of a periodic time period plus a random additional time period.

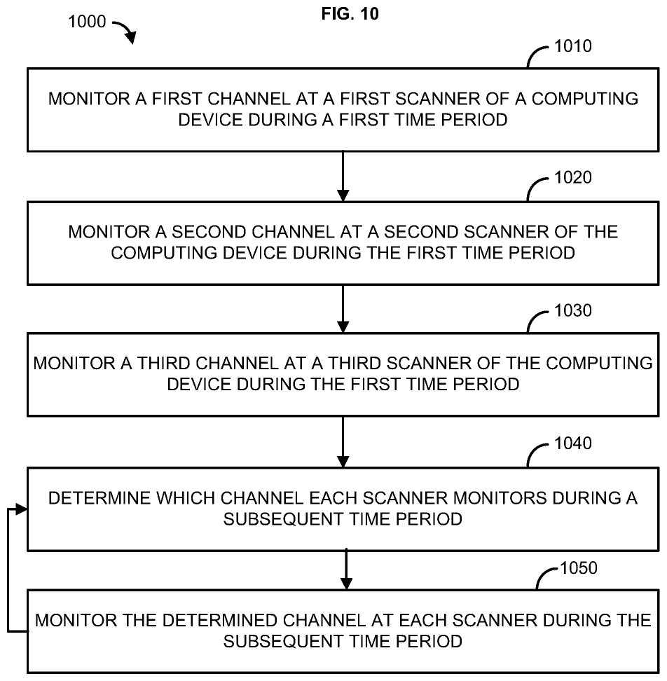

FIG. 10 is a flowchart showing an example method 1000 for monitoring for communication signals associated with one or more devices (e.g., devices 120a-n, 240a-n). The method 1000 may be completed by a computing device (e.g., the computing device 101, or any other computing device).

At 1010, a first wireless channel may be monitored during a first time period. For example, the first wireless channel may be monitored by the first scanner 102 of the computing device 101. For example, the computing device 101 may comprise a plurality of scanners (e.g., the first scanner 102, the second scanner 104, and the third scanner 106). For example, the computing device 101 may comprise at least as many scanners 102, 104, 106 as there are advertising channels for the particular wireless protocol. Each of the plurality of scanners may be configured to monitor a single wireless channel during a time period (e.g., a scan window). The first wireless channel may be a Bluetooth advertising channel. For example, the Bluetooth protocol includes three advertising channels, channels 37-39. Accordingly, the computing device 101 may comprise at least three scanners 102, 104, 106 so that each advertising channel of the Bluetooth protocol is being monitored by at least one of the scanners 102, 104, 106 of the computing device 101 during each time period (e.g., scan window). However, the computing device 101 having three scanners is just for example purposes only as greater or fewer scanners per computing device 101 is contemplated within the scope of this disclosure.

The computing device 101 may determine which scanner 102, 104, 106 will monitor the first channel of the particular wireless protocol during the first time period. The computing device 101 may determine which scanner 102, 104, 106 will monitor the first channel during the first time period based on at least one of random selection; the number of time periods elapsed since the particular scanner 102, 104, 106 monitored the first channel, the number of scanners 102, 104, 106 available, the number of channels to be scanned, or a cyclical rotation (e.g., scan first channel, scan second channel, scan third channel, repeat). For purposes of example, the computing device 101 may determine that the first scanner 102 will monitor the first channel for signals (e.g., from the plurality of wireless tags 122a-n) during the first time period.

The computing device 101 may determine which antenna the first scanner 102 will use to monitor the first channel. For example, the first scanner 102 may be associated with and/or communicatively coupled to one or more antennas 103a-c. Each of the antennas 103a-c may be positioned along a different portion of the computing device 101 or first scanner 102 or aimed in a different direction from the computing device 101 or first scanner 102. In certain examples, the antennas 103a-c may only be used by the first scanner 102, while in other examples, the antennas 103a-c may be shared and used simultaneously or at different times by each of the scanners 102, 104, 106 of the computing device 101. In certain examples, the computing device 101 may include a single antenna that is used by each of the scanners 102, 104, 106 simultaneously. The computing device 101 may determine which antenna 103a-c will be used by the first scanner 102 to monitor the first channel during the first time period based on at least one of random selection; the number of antennas available to the first scanner 102, the antenna 103a-c used by the first scanner 102 the last time the first scanner 102 monitored the first channel, or a cyclical rotation (e.g., first antenna 103a, second antenna 103b, third antenna 103c, repeat).

The first scanner 102 may monitor (e.g., listen for and receive) the first channel for wireless signals during the first time period. The first time period may be the scan window for the particular wireless communication protocol. For example, the first time period may be any amount of time between 0-100 seconds. For example, the first time period may be any amount of time between 20 milliseconds-10.24 seconds. During the first time period, the first scanner 102 may or may not receive signals (e.g., advertising signals or advertising packets) from one or more of the wireless tags 122a-n associated with corresponding devices 120a-n. For example, if an advertising signal is received from the wireless tag 122a by the antenna 103a associated with the first scanner 102, the first scanner 102 may send the signal or data associated with the signal to the device information database 112 and/or location analyzer 110 to determine the location of the device 120a associated with the wireless tag 122a. For example, if the advertising signal is received from the wireless tag 122a by the antenna 103a associated with the first scanner 102, the first scanner 102 or the computing device 101 may send the signal or data associated with the signal to the remote computing device 134 for analysis to determine the location of the device 120a associated with the wireless tag 122a.

At 1020, a second wireless channel may be monitored during the first time period. For example, the second wireless channel may be monitored by the second scanner 104 of the computing device 101. The second wireless channel may be a Bluetooth advertising channel different from the first wireless channel. The computing device 101 may determine which scanner 102, 104, 106 will monitor the second channel of the particular wireless protocol during the first time period. The computing device 101 may determine which scanner 102, 104, 106 will monitor the second channel during the first time period based on at least one of random selection; the number of time periods elapsed since the particular scanner 102, 104, 106 monitored the second channel, the number of scanners 102, 104, 106 available, the number of channels to be scanned, or a cyclical rotation. For purposes of example, the computing device 101 may determine that the second scanner 104 will monitor the second channel for signals (e.g., from the plurality of wireless tags 122a-n) during the first time period.

The computing device 101 may determine which antenna the second scanner 104 will use to monitor the second channel. For example, the second scanner 104 may be associated with and/or communicatively coupled to one or more antennas 105a-c. Each of the antennas 105a-c may be positioned along a different portion of the computing device 101 or second scanner 104 or aimed in a different direction from the computing device 101 or second scanner 104. The computing device 101 may determine which antenna 105a-c will be used by the second scanner 104 to monitor the second channel during the first time period based on at least one of random selection; the number of antennas available to the second scanner 104, the antenna 105a-c used by the second scanner 104 the last time the second scanner 104 monitored the second channel, or a cyclical rotation.

The second scanner 104 may monitor (e.g., listen for and receive) the second channel for wireless signals during the first time period. During the first time period, the second scanner 104 may or may not receive signals (e.g., advertising signals or advertising packets) from one or more of the wireless tags 122a-n associated with corresponding devices 120a-n. For example, if an advertising signal is received from the wireless tag 122c by the antenna 105b associated with the second scanner 104, the second scanner 104 may send the signal or data associated with the signal to the device information database 112 and/or location analyzer 110 to determine the location of the device 120c associated with the wireless tag 122a at the computing device 101. For example, if the advertising signal is received from the wireless tag 122c by the antenna 105b associated with the second scanner 104, the second scanner 104 or the computing device 101 may send the signal or data associated with the signal to the remote computing device 134 for analysis to determine the location of the device 120c associated with the wireless tag 122c.

At 1030, a third wireless channel may be monitored during the first time period. For example, the third wireless channel may be monitored by the third scanner 106 of the computing device 101. The third wireless channel may be a Bluetooth advertising channel different from the first and second wireless channels. The computing device 101 may determine which scanner 102, 104, 106 will monitor the third channel of the particular wireless protocol during the first time period. The computing device 101 may determine which scanner 102, 104, 106 will monitor the third channel during the first time period based on at least one of random selection; the number of time periods elapsed since the particular scanner 102, 104, 106 monitored the third channel, the number of scanners 102, 104, 106 available, the number of channels to be scanned, or a cyclical rotation. For purposes of example, the computing device 101 may determine that the third scanner 106 will monitor the third channel for signals (e.g., from the plurality of wireless tags 122a-n) during the first time period.

The computing device 101 may determine which antenna the third scanner 106 will use to monitor the third channel. For example, the third scanner 106 may be associated with and/or communicatively coupled to one or more antennas 107a-c. Each of the antennas 107a-c may be positioned along a different portion of the computing device 101 or third scanner 106 or aimed in a different direction from the computing device 101 or third scanner 106. The computing device 101 may determine which antenna 107a-c will be used by the third scanner 106 to monitor the third channel during the first time period based on at least one of random selection; the number of antennas available to the third scanner 106, the antenna 107a-c used by the third scanner 106 the last time the third scanner 106 monitored the third channel, or a cyclical rotation.

The third scanner 106 may monitor (e.g., listen for and receive) the third channel for wireless signals during the first time period. During the first time period, the third scanner 106 may or may not receive signals (e.g., advertising signals or advertising packets) from one or more of the wireless tags 122a-n associated with corresponding devices 120a-n. For example, if an advertising signal is received from the wireless tag 122d by the antenna 107c associated with the third scanner 106, the third scanner 106 may send the signal or data associated with the signal to the device information database 112 and/or location analyzer 110 to determine the location of the device 120d associated with the wireless tag 122d at the computing device 101. For example, if the advertising signal is received from the wireless tag 122d by the antenna 107c associated with the third scanner 106, the third scanner 106 or the computing device 101 may send the signal or data associated with the signal to the remote computing device 134 for analysis to determine the location of the device 120d associated with the wireless tag 122d.

At 1040, the channel each scanner will monitor during a subsequent time period may be determined. For example, the computing device 101 may determine the channel each scanner 102, 104, 106 will monitor during the subsequent time period. For example, the subsequent time period may be the time period immediately after the first time period or the time period after the first time period plus a scan interval (e.g., an amount of time between two consecutive scan windows). The scan interval may be a fixed period of time or an adjustable period of time (e.g., the fixed period of time plus a random time addition).

For example, the computing device 101 may determine which scanner 102, 104, 106 will monitor the first channel, the second channel, and the third channel during the subsequent time period based on at least one of random selection; the number of time periods elapsed since the particular scanner 102, 104, 106 monitored the particular channel, the number of scanners 102, 104, 106 available, the number of channels to be scanned, or a cyclical rotation (e.g., scan first channel, scan second channel, scan third channel, repeat). For purposes of example, the computing device 101 may determine that the first scanner 102 will monitor the second channel, the second scanner 104 will monitor the third channel, and the third scanner 106 will monitor the first channel, for signals (e.g., from the plurality of wireless tags 122a-n) during the subsequent time period.

The computing device 101 may also determine which antennas the first scanner 102 will use to monitor the second channel, the second scanner 104 will use to monitor the third channel and the third scanner 106 will use to monitor the first channel. For example, the computing device 101 may determine which antennas will be used by the scanners 102, 104, 106 to monitor the second channel, third channel, and first channel respectively during the subsequent time period based on at least one of random selection; the number of antennas available to each particular scanner 102, 104, 106, the antenna used by the particular scanner 102, 104, 106 the last time the scanner 102, 104, 106 monitored the particular channel, or a cyclical rotation.

At 1050, each scanner 102, 104, 106 may monitor the determined channels during the subsequent time period. Based on the example above, the first scanner 102 may monitor the second channel, the second scanner 104 may monitor the third channel, and the third scanner 106 may monitor the first channel. However, a number of other iterations are possible based on the number of scanners and the number of channels to be monitored and each is considered within the scope of this disclosure. As signals are received during the subsequent time period, the particular scanner 102, 104, 106 may send the signal or data within the signal for processing to determine the location of the device 120a-n associated with the wireless tag 122a-n that sent the signal as described above. The method 1000 may then return to 1040 to determine which channel each scanner 102, 104, 106 will monitor for the next subsequent time period.

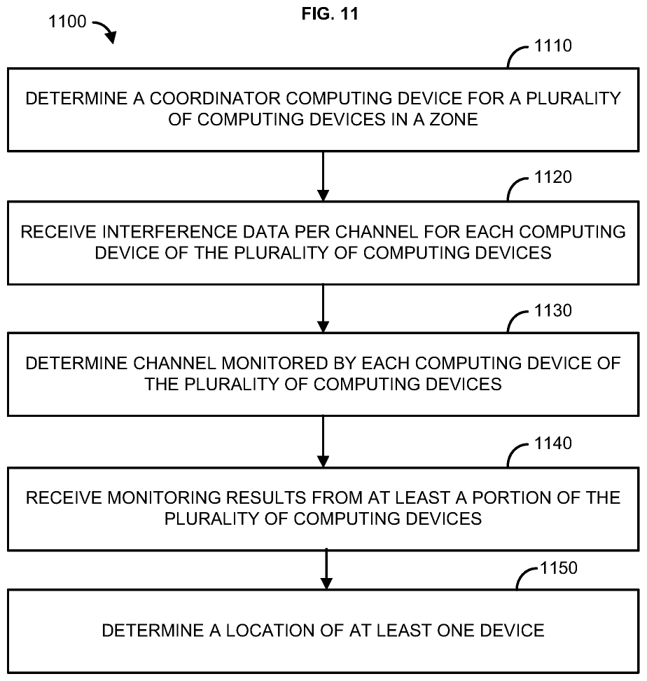

FIG. 11 is a flowchart showing another example method 1100 for monitoring for communication signals associated with one or more devices (e.g., devices 240a-n). The method 1100 may be completed by any one or more of the computing devices 201, 214, 220, 226, or any other computing device). The computing devices 201, 214, 220, 226, may be a portion of a plurality of computing devices. Each of the plurality of computing devices may include a scanner (e.g., scanner 202, 216, 222, 228) for receiving signals from one or more wireless tags (e.g., wireless tags 242a-n) within a zone. Each scanner 202, 216, 222, 228, may be within zone 232 of a plurality of zones within an area for which location determination is being conducted for devices (e.g., devices 240a-n). For example, each zone may be a room, portion of the room, a plurality of rooms, or a floor of a building, or a portion of an outdoor area.

Each computing device may include one or more antennas (e.g., antennas 212a-c, 218a-c, 224a-c, 230a-c) that are coupled to or communicatively coupled with the respective scanner of the computing device. For computing devices having more than one antenna, each antenna associated with the computing device may be positioned along a different portion of the computing device or associated scanner or aimed in a different direction from the computing device or scanner.

Each computing device 201, 214, 220, 226, and thus each respective scanner 202, 216, 222, 228, within the zone 232 may be communicatively connected to one another to coordinate scanning activities between the computing devices 201, 214, 220, 226. For example, the computing devices 201, 214, 220, 226 may be communicatively connected via a data bus (not shown). For example, the computing devices 201, 214, 220, 226, may be communicatively coupled to one-another via Ethernet cable. The computing devices 201, 214, 220, 226 may be configured to communicate with one-another via Bluetooth, BLE, LoRa, UWB, Wi-Fi, CAN Bus, RS485 or any other wired or wireless protocol. For example, one computing device (e.g., computing device 201 may include a power source (e.g., power source 210) and the computing devices 201, 214, 220, 226 may share the power source to power all of the computing devices 201, 214, 220, 226. While the example of FIG. 2 shows each of the computing devices 201, 214, 220, 226 within the zone 232, in other examples, at least a portion of the computing devices communicatively coupled together may be in one or more other zones.

Each scanner 202, 216, 222, 228 of each computing device 201, 214, 220, 226 within the zone 232 may scan one or more channels of a wireless communication protocol. For example, the wireless communication protocol may be Bluetooth or BLE. For example, each scanner 202, 216, 222, 228 may scan each of the advertising channels (e.g., the three advertising channels 37-39) of the Bluetooth or BLE protocol. Each scanner 202, 216, 222, 228 or its associated computing device 201, 214, 220, 226 may determine the RF noise and/or RF interference level that the particular scanner 202, 216, 222, 228 has for each channel. Each computing device 201, 214, 220, 226 may then determine to monitor the channel with the lowest RF noise and/or RF interference at the associated scanner 202, 216, 222, 228.

For example, if the computing device 201 determines that the first scanner 202 has the lowest RF noise and/or RF interference while monitoring the first advertising channel, then the computing device 201 may signal or configure the scanner 202 to monitor the first advertising channel. For example, if the computing device 214 determines that the second scanner 216 has the lowest RF noise and/or RF interference while monitoring the second advertising channel, then the computing device 214 may signal or configure the scanner 216 to monitor the second advertising channel. For example, if the computing device 220 determines that the third scanner 222 has the lowest RF noise and/or RF interference while monitoring the first advertising channel, then the computing device 220 may signal or configure the scanner 222 to monitor the first advertising channel. For example, if a computing device 226 determines that the fourth scanner 228 has the lowest RF noise and/or RF interference while monitoring the second advertising channel, then the computing device 226 may signal or configure the scanner 228 to monitor the second advertising channel.

A determination may be made as to whether all available advertising channels are being monitored by the scanners 202, 216, 222, 228 of the group of computing devices 201, 214, 220, 226. For example, the determination may be made by any one of the computing devices 201, 214, 220, 226 within the zone 232. For example, each of the computing devices 201, 214, 220, 226 may send to each other computing device 201, 214, 220, 226 an indication (e.g., a message or signal) of the computer ID (e.g., MAC address), the zone the computing device is in, and the channel the computing device is monitoring. In the example above, the first and second advertising channels are being monitored, but the third advertising channel is not.

At 1110, a coordinator computing device for the plurality of computing devices in a zone may be determined. For example, the coordinator computing device may be determined by any one of the plurality of computing device (e.g., the computing devices 201, 214, 220, 226) in the zone 232. For example, the coordinator computing device may be one of the plurality of computing devices 201, 214, 220, 226. The coordinator computing device may coordinate which channel will be monitored by the scanner for all or a portion of the computing devices 201, 214, 220, 226 in order to ensure that all desired channels (e.g., advertising channels) are being monitored during each time period (e.g., scan window). The coordinator computing device may be selected randomly from the computing devices 201, 214, 220, 226 in the zone 232. For example, the coordinator computing device may be selected based on the method 900 described in FIG. 9 below. For example, for purposes of discussion, the computing device 201 may be determined to be the coordinator computing device.

At 1120, interference data and/or noise data may be received for each channel for each of the computing devices. For example, the interference data and/or the noise data may be received by the coordinator computing device 201. For example, the interference data and/or the noise data may be received by the computing device 201 based on the computing device being determined to be the coordinator computing device 201. The interference data and/or noise data may be received by the coordinator computing device 201 as part of a message from each one of the plurality of computing devices 214, 220, 226. The interference data may be RF interference data and the noise data may be RF noise data. The message may be sent by each computing device 214, 220, 226 communicatively coupled together with the coordinator computing device 201. The message may include the RF noise data for each channel, the RF interference data for each channel, a computing device ID (e.g., a MAC address) for the particular computing device 214, 220, 226 and a zone identifier identifying the zone (e.g., the zone 232 or another zone of the area) that the computing device 214, 220, 226 is located within.

At 1130, the channel to be monitored by each computing device of the plurality of computing devices may be determined. For example, the coordinator computing device 201 may determine the channel to be monitored by each computing device 201, 214, 220, 226 of the plurality of computing devices 201, 214, 220, 226. For example, the coordinator computing device 201 may evaluate the RF noise and/or RF interference each computing device 201, 214, 220, 226 recorded for each channel (e.g., each advertising channel) of the plurality of channels. An example table of RF noise for each channel for each computing device 201, 214, 220, 226 is provided below for reference.

TABLE 1

| | | Ad Channel | Ad Channel | Ad Channel |
|---|---|---|---|---|
| | Computing | 1 Noise | 2 Noise | 3 Noise |
| | device ID | Level | Level | Level |
| Computing | MAC | −96 dBm | −84 dBm | −93 dBm |
| device 201 | address 1 | | | |
| Computing | MAC | −70 dBm | −92 dBm | −81 dBm |
| device 214 | address 2 | | | |
| Computing | MAC | −32 dBm | −86 dBm | −91 dBm |
| device 220 | address 3 | | | |
| Computing | MAC | −60 dBm | −82 dBm | −90 dBm |
| device 226 | address 4 | | | |

For example, the coordinator computing device 201 may determine the channel to be monitored by each computing device 201, 214, 220, 226 based on which computing device 201, 214, 220, 226 has the lowest RF noise or RF interference for the particular channel, while still ensuring that each channel is monitored by at least one scanner of the associated computing device 201, 214, 220, 226. For example, as shown in Table 1, the coordinator computing device 201 may determine that the computing device 201 (e.g., the coordinator computing device 201) will monitor the first channel (e.g., the first advertising channel for the wireless protocol) based on the computing device 201 having the lowest RF noise level for the first channel. The coordinator computing device 201 may determine that the computing device 214 will monitor the second channel (e.g., the second advertising channel for the wireless protocol) based on the computing device 214 having the lowest RF noise level for the second channel. For the third channel (e.g., the third advertising channel for the wireless protocol), the coordinator computing device 201 may determine that the computing device 201 has the lowest noise level. However, the computing device 201 has already be determined to monitor the first channel. The coordinator computing device 201 may then identify the next lowest noise level for the third channel, and may identify the computing device 220 as having the next lowest noise level for the third channel. Accordingly, the coordinator computing device 201 may determine that the computing device 220 will monitor the third channel.

The coordinator computing device 201 may determine that each channel (e.g., each advertising channel) has been assigned at least one computing device of the plurality of computing devices 201, 214, 220, 226 to monitor the particular channel and that additional computing devices remain to be assigned (e.g., the computing device 226). The coordinator computing device 201 may determine that the computing device 226 will monitor any one of the channels. For example, the coordinator computing device 201 may randomly select one of the channels to be monitored by each of the additional computing devices (e.g., the computing device 226). For example, the coordinator computing device 201 may determine for which channel each of the additional computing devices had the lowest RF noise and determine that each additional computing device will monitor that particular channel. In the example of Table 1, the lowest noise level for the computing device 226 was while scanning the third channel. Accordingly, the coordinator computing device 201 may determine that the computing device 226 will monitor the third channel. Other techniques may be used to determine what channel to assign to each of the additional computing devices once at least each channel is determined to be monitored by one of the computing devices 201, 214, 220, 226 in the area 232. Each of the computing devices 201, 214, 220, 226 may use associated scanners 202, 216, 222, 228 to monitor their respective determined channels for signals from one or more wireless tags 242a-n associated with the respective devices 240a-n.

At 1140, monitoring results may be received from at least a portion of the plurality of computing devices (e.g., the computing devices 201, 214, 220, 226). For example, a plurality of monitoring results may be received by all or apportion of the computing devices 201, 214, 220, 226. For example, the coordinator computing device 201 may receive the monitoring results from one or more of the computing devices 201, 214, 220, 226. For example the monitoring results may comprising advertising signals. The one or more computing devices 201, 214, 220, 226 may receive the advertising signals from one or more wireless tags 142a-n associated with the corresponding devices 140a-n in the zone 232. Each advertising signal may comprise a data packet. The data packet may comprise an advertising packet header and a packet body. The signal (e.g., the data packet) may include a device identifier (ID), the capabilities of the wireless tag, the functionality of the wireless tag, and/or the intention of the wireless tag. The device ID may identify the sending wireless tag 242a-n and/or the associated device 240a-n to which the particular wireless tag 242a-n is connected. The monitoring results may also comprise an RSSI for the signal. The RSSI for the signal may be determined by the scanner 202, 216, 222, 228 of the computing device 201, 214, 220, 226 that receives the signal from the particular wireless tag 242a-n. The monitoring results may also comprise a scanner identifier that identifies the scanner 202, 216, 222, 228 of the corresponding computing device 201, 214, 220, 226 that received the signal from the wireless tag 242a-n.

In certain examples, the coordinator computing device 201 may store the received monitoring results (e.g., the device ID, the capabilities, the functionality, the intention data, RSSI for the signal, and the scanner identifier) in the device information database 208 or another storage device of the coordinator computing device 201. In other examples, the coordinator computing device 201 may send or otherwise transmit the received monitoring results to the remote computing device 256 via the network 254 or another network.

At 1150, the location of at least one device (e.g., at least one of the devices 240a-n) may be determined. For example, the location may be determined by the coordinator computing device 201 or the remote computing device 256. For example, the coordinator computing device 201 may determine the location of the at least one device 240a-n based on the monitoring results received that are associated with the particular device 240a-n. For example, the coordinator computing device 201 may determine the location of the particular device 240a-n based on the scanner identifier and the RSSI of the monitoring results. For example, the coordinator computing device 201 may determine, based on the scanner identifier, the location of the scanner 202, 216, 222, 228 that received the particular monitoring results associated with the particular device 240a-n. The coordinator computing device 201 may determine the location of the particular device 240a-n based on the location of the particular scanner 202, 216, 222, 228 and the RSSI for the signal from the wireless tag 242a-n associated with the particular device 240a-n.

For example, the coordinator computing device 201 may determine the location of the particular device 240a-n based on a plurality of monitoring results associated with the particular device 240a-n. For example, the coordinator computing device 201 may determine, based on the scanner identifier, the location of the scanner 202, 216, 222, 228 that received each particular monitoring results of the plurality of monitoring results associated with the particular device 240a-n. The coordinator computing device 201 may determine the location of the particular device 240a-n based on the location of each scanner 202, 216, 222, 228 that received the particular monitoring results and the RSSI or time difference of arrival (TDoA) for the particular signal in the monitoring results. For example, the coordinator computing device 201 may determine the location of the particular device 240a-n based on triangulation of using three monitoring results from three different scanners 202, 216, 222, 228, and associated with the same device 240a-n in the zone 232. The coordinator computing device 201 may send or otherwise transmit the location information for the particular device 240a-n to the remote computing device 256 via the network 254 or another network. In other examples, the location of the at least one device 240a-n may be determined by the remote computing device 256 in substantially the same manners as described above with respect to the coordinator computing device 201.

The scanners 202, 216, 222, 228 may monitor their determined channels for a period of time or until the RF noise at one or multiple computing devices 201, 214, 220, 226 of the plurality of computing devices satisfies a predefined noise threshold. The period of time may be substantially greater than the standard scan window for an advertising channel for the particular wireless protocol. Once the period of time expires or the RF noise satisfies the noise threshold, the method 1100 may return to 1110 or 1120 if another coordinator computing device is not being determined at the particular time.

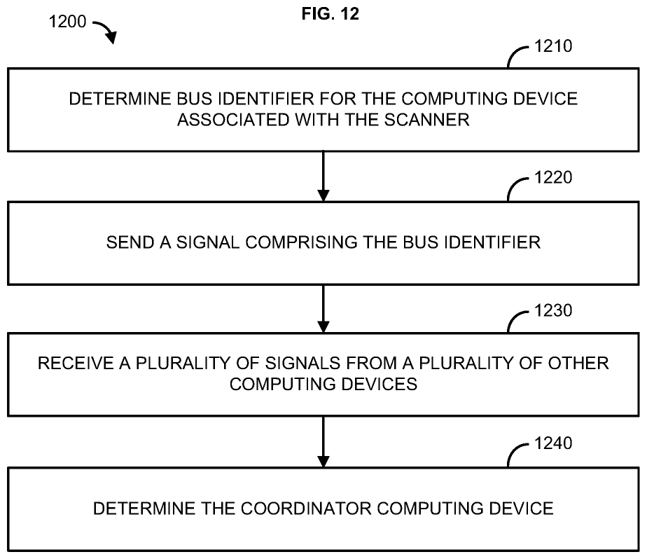

FIG. 12 is a flowchart showing another example method 1200 for determining a coordinator computing device from a plurality of computing devices (e.g., computing devices 201, 214, 220, 226). The method 1200 may be completed by any one or more of the computing devices 201, 214, 220, 226, or any other computing device). The computing devices 201, 214, 220, 226, may be a portion of a plurality of computing devices. Each of the plurality of computing devices may include a scanner (e.g., scanner 202, 216, 222, 228) for receiving signals from one or more wireless tags (e.g., wireless tags 242a-n) within a zone. Each scanner 202, 216, 222, 228, may be within zone 232 of a plurality of zones within an area for which location determination is being conducted for devices (e.g., devices 240a-n).

At 1210, the bus identifier for the computing device associated with the scanner may be determined. For example, the computing device may be any one of the computing devices 201, 214, 220, 226. The bus identifier may be determined based on the MAC address for the particular computing device 201, 214, 220, 226. For example, the bus identifier may be determined for each of the computing devices 201, 214, 220, 226 based on the MAC address for each of the computing devices. For example, the bus identifier for the particular computing device 201, 214, 220, 226 may be based on the least significant bits of the MAC address for the particular computing device 201, 214, 220, 226. For example, the bus identifier for the particular computing device 201, 214, 220, 226 may the least significant bits of the MAC address for the particular computing device 201, 214, 220, 226.

At 1220, a signal may be sent. For example, the signal may be sent by the scanner 202, 216, 222, 228 associated with the particular computing device 201, 214, 220, 226 associated with the bus identifier. For example the signal may be sent by the particular scanner 202, 216, 222, 228 via any wireless protocol. For example, the signal may be any one of a Bluetooth signal, a BLE signal, a Wi-Fi signal, a ZigBee signal, an ultra-wide band (UWB) signal, a controller area network (CAN) bus signal, an RS485 signal, a near-field communication (NFC) signal, or a LoRa signal. The signal may be a broadcast signal. For example, the broadcast signal may be an advertising signal. For example, the broadcast signal may be sent by the particular scanner 202, 216, 222, 228 associated with the particular computing device 201, 214, 220, 226 during a scan interval. For example, the signal may comprising a packet. The packet may include a packet header and a packet body. The packet may include the zone identifier identifying the zone (e.g., the zone 232 or another zone of the area) that the particular computing device 201, 214, 220, 226 is located within, a device ID (e.g., the MAC address for the computing device 201, 214, 220, 226), and the bus identifier for the particular computing device 201, 214, 220, 226.

At 1230, a plurality of signals from a plurality of other computing devices may be received. For example, the plurality of signals may be received by one of the computing devices 201, 214, 220, 226 from one or more of the remaining computing devices 201, 214, 220, 226. For example, the plurality of signals may be received by the scanner 202, 216, 222, 228 associated with the particular computing device 201, 214, 220, 226. For example, the scanner 202, 216, 222, 228 associated with each of the computing devices 201, 214, 220, 226 may listen or monitor for a listening period to receive the plurality of signals from each other one of the computing devices 201, 214, 220, 226. For example, the listening period may be any period of time from about 20 milliseconds-1000 seconds. For example, the listening period may be at or approximately ten times the scan interval for the wireless protocol being used.

At 1240, the coordinator computing device may be determined. For example, the coordinator computing device may be determined by any one of the computing devices 201, 214, 220, 226. For example, one or more of the computing devices 201, 214, 220, 226 may compare bus identifier of the received signals from the other computing devices 201, 214, 220, 226 and the bus identifier for the particular computing device 201, 214, 220, 226 for each of the computing devices in the same zone (e.g., zone 232 or another zone in the area being monitored) to determine the coordinator computing device for the zone. For example, the coordinator computing device may be the computing device 201, 214, 220, 226 with the lowest bus identifier in the zone. For example, the computing device 201, 214, 220, 226 that determines that it has the lowest bus identifier for each of the computing devices 201, 214, 220, 226 comprising one or more scanners 202, 216, 222, 228 in the zone 232 may designate itself as the coordinator computing device. For purposes of example, the computing device 201 may determine that it has the lowest bus identifier of the computing devices 201, 214, 220, 226 in the zone 232 and may be designated the coordinator computing device 201.

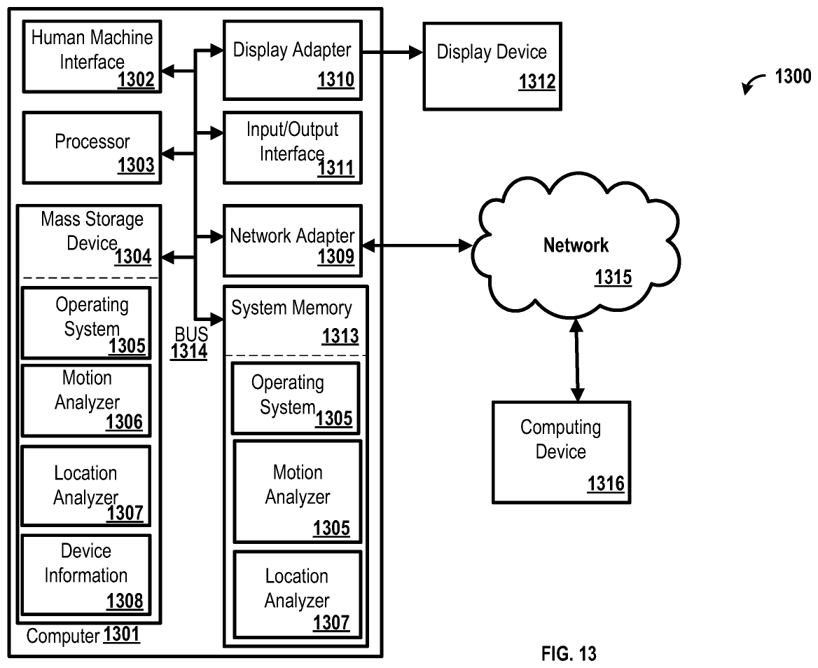

FIG. 13 shows a system 1300 for determining the locations of a plurality of devices. Any one or more of the computing device 101 or remote computing device 134, of FIG. 1 or the computing device 201, computing device 214, computing device 220, computing device 226, or remote computing device 256 of FIG. 2 may be a computer 1301 as shown in FIG. 13.

The computer 1301 may comprise one or more processors 1303, a system memory 1313, and a bus 1314 that couples various components of the computer 1301 including the one or more processors 1303 to the system memory 1313. In the case of multiple processors 1303, the computer 1301 may utilize parallel computing.

The bus 1314 may comprise one or more of several possible types of bus structures, such as a memory bus, memory controller, a peripheral bus, an accelerated graphics port, and a processor or local bus using any of a variety of bus architectures.

The computer 1301 may operate on and/or comprise a variety of computer-readable media (e.g., non-transitory). Computer-readable media may be any available media that is accessible by the computer 1301 and includes, non-transitory, volatile and/or non-volatile media, and removable and non-removable media. The system memory 1313 has computer-readable media in the form of volatile memory, such as random access memory (RAM), and/or non-volatile memory, such as read-only memory (ROM). The system memory 1313 may store data and/or program modules such as an operating system 1305, the motion analyzer module 1306, and location analyzer module 1307 that are accessible to and/or are operated on by the one or more processors 1303.

The computer 1301 may also comprise other removable/non-removable, volatile/non-volatile computer storage media. The mass storage device 1304 may provide non-volatile storage of computer code, computer-readable instructions, data structures, program modules, and other data for the computer 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, RAM, ROM, electrically erasable programmable read-only memory (EEPROM), and the like.

Any number of program modules may be stored on the mass storage device 1304. An operating system 1305, motion analyzer module 1306, and location analyzer module 1307 may be stored on the mass storage device 1304. One or more of the operating system 1305 motion analyzer module 1306, and location analyzer module 1307 (or some combination thereof) may comprise one or more program modules. Device information data 1308 may also be stored on the mass storage device 1304.

Device information data 1308 may comprise information associated with a plurality of devices (e.g., devices 120a-n, 240a-n) within an area being monitored. The plurality of devices may be tens, hundreds, or thousands of devices within the area being monitored. For example, the information associated with each device may comprise a device ID, a wireless tag device ID for a wireless tag associated with the particular device, a location for the device, a zone identifier associated with a zone within which the device is located, one or more RSSI's for one or more signals associated with a wireless tag associated with the particular device, motion data and the like. The device information 1308 may be stored in any of one or more databases known in the art. The databases may be centralized or distributed across multiple locations within the network 1315.

A user may enter commands and information into the computer 1301 via an input device (not shown). Such input devices include, but are not limited to, a keyboard, pointing device (e.g., a computer mouse or remote control), a microphone, a joystick, a scanner, tactile input devices such as gloves, and other body coverings, a motion sensor, and the like These and other input devices may be connected to the one or more processors 1303 via a human-machine interface 1302 that is coupled to the bus 1314, but may be connected by other interface and bus structures, such as a parallel port, game port, an IEEE 1394 Port (also known as a Firewire port), a serial port, network adapter 1309, and/or a universal serial bus (USB).

A display device 1312 may also be connected to the bus 1314 via an interface, such as a display adapter 1310. It is contemplated that the computer 1301 may have more than one display adapter 1310 and the computer 1301 may have more than one display device 1312. A display device 1312 may be a monitor, an LCD (Liquid Crystal Display), a light-emitting diode (LED) display, a television, smart lens, smart glass, and/or a projector. In addition to the display device 1312, other output peripheral devices may comprise components such as speakers (not shown) and a printer (not shown) which may be connected to the computer 1301 via Input/Output Interface 1311. Any step and/or result of the methods may be output (or caused to be output) in any form to an output device. Such output may be any form of visual representation, including, but not limited to, textual, graphical, animation, audio, tactile, and the like. The display 1312 and computer 1301 may be part of one device, or separate devices.

The computer 1301 may operate in a networked environment using logical connections to one or more computing devices, such as the remote computing device 1316. The remote computing device 1316 may be a personal computer, computing station, workstation, portable computer, laptop computer, a network computer, a server or cloud computing device, and so on. Logical connections between the computer 1301 and the remote computing device 1316 may be made via a network 1315, such as a local area network (LAN) and/or a general wide area network (WAN) and one or more network devices (e.g., a router, an edge device, an access point or other common network nodes). Such network connections may be through a network adapter 1309. A network adapter 1309 may be implemented in both wired and wireless environments. Such networking environments are conventional and commonplace in dwellings, offices, enterprise-wide computer networks, intranets, and the Internet.

Application programs and other executable program components such as the operating system 1305, the motion analyzer module 1306, and the location analyzer module 1307 are shown herein as discrete blocks, although it is recognized that such programs and components may reside at various times in different storage components of the computing device 1301, and are executed by the one or more processors 1303 of the computer 1301. An implementation of the motion analyzer module 1306 and/or the location analyzer module 1307 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device and from a first device, a signal;
determining, based on the signal, that the first device is in motion;
determining, based on the first device being in motion, to cease determining a location of the first device; and
causing location determination for the first device to cease.

2. The method of claim 1, further comprising:
receiving, from the first device a second signal, wherein the second signal indicates that the first device is not in motion; and
determining a second location of the first device.

3. The method of claim 2, wherein the second signal is received by a first scanner of the computing device and wherein determining the second location of the first device comprises:
receiving, by a second scanner of the computing device and from the first device, a third signal;
receiving, by a third scanner of the computing device and from the first device, a fourth signal; and
determining, based on the second signal, the third signal, and the fourth signal, the second location for the first device.

4. The method of claim 2, wherein the second signal is received by the computing device and wherein determining the second location of the first device comprises:
receiving, by a second computing device and from the first device, a third signal;
receiving, by a computing device and from the first device, a fourth signal; and
determining, based on the second signal, the third signal, and the fourth signal, the second location for the first device.

5. The method of claim 2, wherein determining the second location of the first device comprises:
determining a signal strength of the second signal; and
determining, based on the signal strength and a location of the computing device, the second location.

6. The method of claim 1, wherein the signal comprises motion data and wherein determining that the first device is in motion comprises determining, based on the motion data, the first device is in motion.

7. The method of claim 6, wherein the motion data comprises at least one of a quantity of acceleration, a quantity of velocity, or a motion indication, for the first device.

8. The method of claim 1, wherein determining that the first device is in motion comprises:
comparing a signal strength of the signal to a second signal strength of another signal from the first device; and
determining, based on a difference between the signal strength and the second signal strength, that the first device is in motion.

9. The method of claim 1, wherein the signal comprises a Bluetooth signal.

10. A method comprising:
receiving, by a computing device, a signal associated with a first device;
determining a signal strength for the signal;
determining, based on the signal strength of the signal, that the first device is in motion; and
causing location determination for the first device to cease.

11. The method of claim 10, wherein determining that the first device is in motion comprises:
comparing the signal strength to a prior signal strength of a prior signal from the first device; and
determining, based on a difference between the signal strength and the prior signal strength, that the first device is in motion.

12. The method of claim 10, wherein the signal strength comprises a received signal strength indicator quantity.

13. The method of claim 10, further comprising:
receiving a second signal associated with the first device; and
determining, based on a second signal strength of the second signal and a location of the computing device, a second location of the first device.

14. The method of claim 10, further comprising:
determining, based on a second signal strength of a second signal associated with the first device, that the first device is not in motion; and
causing, based on the first device not being in motion, the location determining for the first device to resume.

15. The method of claim 10, further comprising:
determining, based on a second signal strength of a second signal associated with the first device, that the first device is not in motion; and
determining, based on the first device not being in motion, the location of the first device.

16. The method of claim 10, wherein the signal is a wireless signal.

17. A method comprising:
sending, by a device, a wireless signal;
determining, based on motion data for the device, that the device is in motion; and
discontinuing, based on the device being in motion, the sending of the wireless signal.

18. The method of claim 17, further comprising receiving, by the device, the motion data.

19. The method of claim 17, further comprising:
determining, based on second motion data, that the device is not in motion; and
resuming, based on the device not being in motion, the sending of the wireless signal.

20. The method of claim 17, wherein the motion data comprises at least one of a quantity of acceleration, a quantity of velocity, or a motion indication, for the first device.
